(19) United States
(12) Patent Application Publication
(10) Pub. No.: US 2006/0208974 A1
(43) Pub. Date: Sep. 21, 2006

(54) Organic electroluminescent device, driving method thereof and electronic apparatus

(75) Inventor: Hiroyuki Hara, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/354,129

(22) Filed: Feb. 15, 2006

(30) Foreign Application Priority Data
Mar. 18, 2005 (JP) 2005-080086

(51) Int. Cl. G09G 3/30

(52) U.S. Cl. 345/76

(57) ABSTRACT

An organic electroluminescent device, comprises a plurality of pixels each including a light-emitting element, and a drive device adjusting a light-emission period of the light-emitting element included in each of the pixels in accordance with a luminance ratio of an image to be displayed.

### BACKGROUND

1. Technical Field

The present invention relates to an organic electroluminescent (EL) device, a method for driving the organic EL device, and an electronic apparatus.

2. Related Art

An organic EL device having an organic EL element as a light-emitting element that requires no backlight has been drawing attention recently. This organic EL element is made up of a pair of opposing electrodes and an organic EL layer, i.e. a light-emitting element, provided between the electrodes. The organic EL device that provides a full-color display includes a light-emitting element having a range of emission wavelengths for red, green and blue. As a voltage is applied to between the pair of electrodes, injected electrons and holes recombine in the light-emitting element, thereby the element emits light. The light-emitting element included in this organic EL device is formed of a thin film whose thickness is typically less than 1 micrometer. In addition, the device does not require a backlight used in conventional liquid crystal displays, since the light-emitting element provides light. Therefore, the device has an advantage in that it can be made extremely thin.

The cathode ray tube (CRT), which has been widely used for displays, provides a peak luminance display to enhance the luminance of a light-emission area that makes up a rather small part of an entire display. Taking an example of displaying images of fireworks, the luminance of a small display area showing sparkling fireworks is set higher when the area is mostly on a dark background than it is mostly on a bright background. This method can provide highly contrasted images. There has been developed a technology to provide a peak luminance display with an organic EL device. The method changes levels of voltage applied to an organic EL element in accordance with the ratio of an emission area to an entire display. JP-A-2002-297097 and Inverter kairo wo mochiita den'atsukudogata yuki EL display (Voltage-Driven Organic EL Display with an Inverter Circuit) (Hajime Akimoto, 138th. JOEM Lecture Abstract, Japanese Research Association for Organic Electronics Materials, 13 Jan. 2004, pp. 15-21) are examples of related art.

The peak luminance display is thus available by changing levels of voltage applied to an organic EL element. Changes in the voltage levels to provide the peak luminance display, however, require voltage changes corresponding to the grayscale of display images in line with the changed levels. For example, to represent ten grayscale levels with an organic EL element to which a voltage of 10 V at a maximum is applied, the voltage applied to the element is varied by 1 V. However, when a voltage of 15 V at a maximum is applied to the organic EL element to provide the peak luminance display, the voltage applied to the element to represent every grayscale level has to be varied by 1.5 V. The method of related art therefore makes signal processing complicated.

### SUMMARY

An advantage of the present invention is to provide an organic EL device that is capable of controlling luminance in accordance with the ratio of a light-emission area to an entire display without changing a voltage applied in accordance with the ratio, a method for driving the organic EL device, and an electronic apparatus having the organic EL device.

An organic electroluminescent (EL) device according to one aspect of the invention includes a plurality of pixels each having a light-emitting element, and a drive device adjusting a light-emission period of the light-emitting element included in each pixel in accordance with a luminance ratio of an image to be displayed.

Since the light-emission period of the light-emitting element included in each pixel is adjusted in accordance with the luminance ratio of an image to be displayed (the ratio of an emission area to an entire display), it is possible to make the emission period long when the luminance ratio is small and make the emission period short when the luminance ratio is large, for example. As a result, luminance can be controlled depending on the luminance ratio of an image to be displayed without changing a voltage applied to the light-emitting element, thereby providing highly contrasted images as the CRT does.

Here, the luminance ratio of an image to be displayed refers to the ratio of an integrated luminance when every light-emitting element in the viewing area of an organic EL display produces luminescence at a maximum to an integrated luminance when only some light-emitting elements that are required in accordance with the image produce luminescence. Assuming that Lₘₐₓ represents the maximum luminance of individual light-emitting elements and Lₖ is the number of light-emitting elements that are required to produce luminescence in accordance with image) represents a luminance of individual light-emitting elements when only required light-emitting elements produce luminescence, the luminance ratio Lᵣ of the image satisfies the formula (1):
Lᵣ=ΣLₖ/ΣLₘₐₓ (1)
and the ratio Lᵣ falls within the range of 0 to 1 inclusive.

In the organic EL device, the drive device may adjust the light-emission period of the light-emitting element by adjusting non-emission timing of the light-emitting element included in each of the pixels.

Since the light-emission period of the light-emitting element is adjusted by adjusting non-emission timing of the light-emitting element, it is possible to control luminance in accordance with a luminance ratio of an image to be displayed without making the driving and structure of the light-emitting element much complicated.

The organic EL device may also includes a plurality of write scan lines each provided for a unit composed of a predetermined number of the pixels, a plurality of erase scan lines provided corresponding to the write scan lines, and a plurality of data lines each provided for a unit composed of the predetermined number of the pixels, the data lines extending in a direction orthogonal to the write scan lines and the erase scan lines. The drive device may make the light-emitting element included in each of the pixels emit light via the write scan lines and making the light-emitting element included in each pixel not emit light via the erase scan lines.

In this case, it is preferable that the drive device include a plurality of write scan drivers. Each of the write scan drivers drives a unit composed of a predetermined number of the write scan lines.

In this case, it is preferable that the drive device include a plurality of erase scan drivers. Each of the erase scan drivers drives a unit composed of a predetermined number of the erase scan lines.

In this case, it is preferable that the drive device divide a predetermined unit period into a number of one of the write scan driver and the erase scan drivers and control light-emission and non-emission of the light-emitting element in each divided period.

Since this structure includes the plurality of write scan drivers each driving a unit composed of the predetermined number of the write scan lines and the erase scan drivers and light-emission and non-emission of the light-emitting element are controlled in each divided period, it is possible to reduce flickering. Also, by providing the plurality of drivers, it is possible to reduce the drivers' power consumption.

In the organic EL device, each of the pixels may include a driving element driving the light-emitting element based on a signal from the write scan lines and the data lines, and a compensation circuit compensating characteristic variance of the driving element.

Since each of the pixels includes a compensation circuit that compensates characteristic variance of the driving element that drives the light-emitting element, it is possible to display quality images.

The organic EL device may also include a plurality of scan lines each provided for a unit composed of a predetermined number of the pixels, and a plurality of data lines each provided for a unit composed of the predetermined number of the pixels, the data lines extending in a direction orthogonal to the scan lines. The drive device may divide a period to select one of the plurality of scan lines into a first period and a second period and adjust the light-emission period of the light-emitting element.

In this case, it is preferable that the drive device include a plurality of scan drivers. Each of the scan drivers drives a unit composed of a predetermined number of the scan lines.

In this case, it is preferable that the drive device divide each of the first period and the second period into a number of the scan drivers and control light-emission and non-emission of the light-emitting element in each divided period.

In the organic EL device, each of the pixels may include a driving element driving the light-emitting element based on a signal from the scan lines and the data lines, and a compensation circuit compensating characteristic variance of the driving element.

Since each of the pixels includes a compensation circuit that compensates characteristic variance of the driving element that drives the light-emitting element, it is possible to display quality images.

In the organic EL device, each of the pixels may include a red-light-emitting element, a green-light-emitting element, and a blue-light-emitting element. The drive device may make the red-light-emitting element, the green-light-emitting element, and the blue-light-emitting element included in each of the pixels emit light with identical light-emission timing and make the red-light-emitting element, the green-light-emitting element, and the blue-light-emitting element included in each of the pixels not emit light with identical non-emission timing.

Since the red-light-emitting element, the green-light-emitting element, and the blue-light-emitting element included in each pixel are made emit light with identical light-emission timing and made not emit light with identical non-emission timing, it is possible to control luminance in accordance with a luminance ratio of an image to be displayed without making the driving and structure of the light-emitting element much complicated.

In the organic EL device, the drive device may adjust the light-emission period of the light-emitting element in a way that luminance of the light-emitting element is nonlinear with respect to a luminance ratio of an image to be displayed.

Since the light-emission period of the light-emitting element is adjusted in a way that luminance of the light-emitting element is nonlinear with respect to a luminance ratio of an image to be displayed, it is possible to provide highly contrasted images as CRT displays in related art examples do.

A method for driving an organic EL device including a plurality of pixels each having a light-emitting element according to another aspect of the invention includes adjusting a light-emission period of the light-emitting element included in each of the pixels in accordance with a luminance ratio of an image to be displayed.

Since the light-emission period of the light-emitting element included in each pixel is adjusted in accordance with the luminance ratio of an image to be displayed (the ratio of an emission area to an entire display), it is possible to make the emission period long when the luminance ratio is small and make the emission period short when the luminance ratio is large, for example. As a result, luminance can be controlled depending on the luminance ratio of an image to be displayed without changing a voltage applied to the light-emitting element, thereby providing highly contrasted images as the CRT does.

In the method for driving an organic EL device, the light-emission period of the light-emitting element may be adjusted by adjusting non-emission timing of the light-emitting element included in each of the pixels.

Since the light-emission period of the light-emitting element is adjusted by adjusting non-emission timing of the light-emitting element, it is possible to control luminance in accordance with a luminance ratio of an image to be displayed without making the driving and structure of the light-emitting element much complicated.

In the method for driving an organic EL device, each of the pixels may include a red-light-emitting element, a green-light-emitting element, and a blue-light-emitting element. The red-light-emitting element, the green-light-emitting element, and the blue-light-emitting element included in each of the pixels may be made emit light with identical light-emission timing, and the red-light-emitting element, the green-light-emitting element, and the blue-light-emitting element included in each of the pixels may be made not emit light with identical non-emission timing.

Since the red-light-emitting element, the green-light-emitting element, and the blue-light-emitting element included in each pixel are made emit light with identical light-emission timing and made not emit light with identical non-emission timing, it is possible to control luminance in accordance with a luminance ratio of an image to be displayed without making the driving and structure of the light-emitting element much complicated.

In the method for driving an organic EL device, the light-emission period of the light-emitting element may be adjusted in a way that luminance of the light-emitting element is nonlinear with respect to a luminance ratio of an image to be displayed.

Since the light-emission period of the light-emitting element is adjusted in a way that luminance of the light-emitting element is nonlinear with respect to a luminance ratio of an image to be displayed, it is possible to provide highly contrasted images as CRT displays in related art examples do.

An electronic apparatus according to yet another aspect of the invention includes any of the above-described organic EL device.

This structure provides an electronic apparatus capable of displaying quality images.

### BRIEF DESCRIPTION OF THE DRAWINGS

The invention will be described with reference to the accompanying drawings, wherein like numbers reference like elements.

FIG. 1 is a block diagram illustrating the electrical structure of an organic EL device according to a first embodiment of the invention.

FIG. 2 is a block diagram illustrating the structure of a display panel unit included in the organic EL device according to the first embodiment of the invention.

FIG. 3 is a circuit diagram illustrating the structure of a pixel 20 located at the upper left corner of a display panel included in the organic EL device according to the first embodiment of the invention.

FIG. 4 is a timing chart illustrating signals output from a peripheral drive device 2 to the display panel unit 3 in the first embodiment of the invention.

FIG. 5 is a circuit diagram illustrating the structure of a write scan driver 12 included in the organic EL device according to the first embodiment of the invention.

FIG. 6 is a circuit diagram illustrating the structure of a data driver 14 included in the organic EL device according to the first embodiment of the invention.

FIG. 7 is a diagram for explaining a method for driving an organic EL device according to one embodiment of the invention.

FIG. 8 is a diagram showing an example of luminance control of a cathode ray tube (CRT) display and a liquid crystal display (LCD).

FIG. 9 illustrates another structure example showing a subpixel 20R.

FIG. 10 is a block diagram illustrating the electrical structure of an organic EL device according to a second embodiment of the invention.

FIG. 11 is a block diagram illustrating the structure of a display panel unit included in the organic EL device according to the second embodiment of the invention.

FIG. 12 is a circuit diagram illustrating the structure of the pixel 20 located at the upper left corner of a display panel included in the organic EL device according to the second embodiment of the invention.

FIG. 13 is a timing chart illustrating signals output from the peripheral drive device 2 to the display panel unit 3 in the second embodiment of the invention.

FIG. 14 is a circuit diagram illustrating the structure of a scan driver 16 included in the organic EL device according to the second embodiment of the invention.

FIG. 15 is a circuit diagram illustrating the structure of a data driver 17 included in the organic EL device according to the second embodiment of the invention.

FIG. 16 is a diagram for explaining a method for driving an organic EL device according to a third embodiment of the invention.

FIG. 17 is a diagram illustrating electronic apparatus examples of the invention.

### DESCRIPTION OF EXEMPLARY EMBODIMENTS

Exemplary embodiments of an organic EL device, a method for driving the organic EL device and an electronic apparatus according to the invention are hereinafter described with reference to the accompanying drawings. The embodiments below are shown by way of example, and not intended to limit the invention. It is understood that various modifications can be made without departing from the spirit and scope of the invention. Note that the scale of each layer and member is adequately changed so that they are visible in the drawings.

### First Embodiment

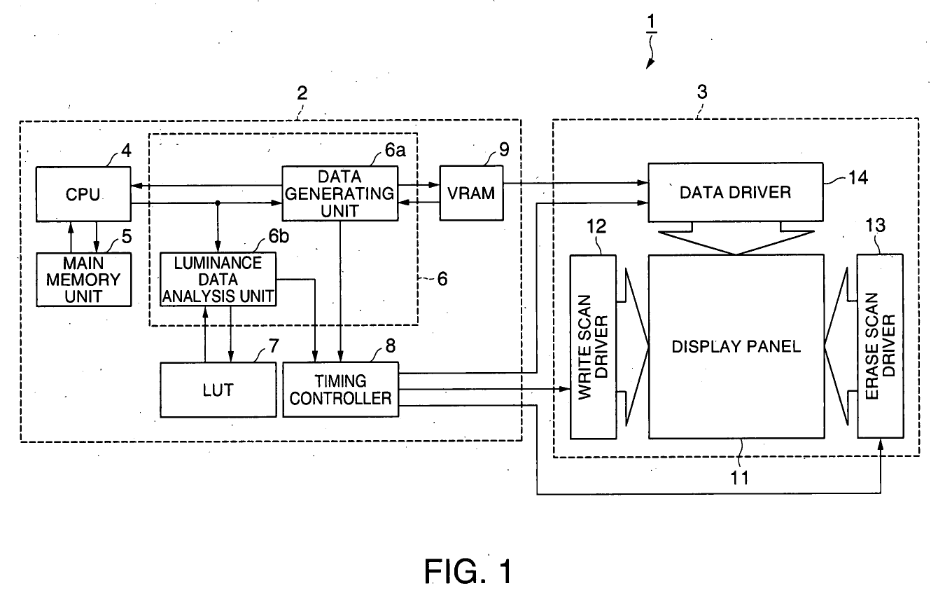

FIG. 1 is a block diagram illustrating the electrical structure of an organic EL device according to a first embodiment of the invention. Referring to the diagram, this organic EL device 1 includes a peripheral drive device 2 and a display panel unit 3. The peripheral drive device 2 includes a central processing unit (CPU) 4, a main memory unit 5, a graphics controller 6, a lookup table (LUT) 7, a timing controller 8 and a video RAM (VRAM) 9. The CPU 4 may be replaced with a microprocessor unit (MPU). The display panel unit 3 includes a display panel 11, a write scan driver 12, an erase scan driver 13 and a data driver 14.

The CPU included in the peripheral drive device 2 reads image data stored in the main memory unit 5, carries out various types of processing, such as expansion, with the main memory unit 5, and outputs processed data to the graphics controller 6. The graphics controller 6 produces image data and synchronizing signals (vertical and horizontal synchronizing signals) for the display panel unit 3 based on the image data output from the CPU 4. The graphics controller 6 transfers the image data generated by its data generating unit 6a to the VRAM 9 and outputs the produced synchronizing signals to the timing controller 8.

The graphics controller 6 also includes a luminance data analysis unit 6b that calculates a luminance ratio of the image data output from the CPU 4 based on the data. Here, the luminance ratio of image data refers to the ratio of an integrated luminance when every pixel included in the display panel 11, which will be described in greater detail later, produces luminescence at a maximum to an integrated luminance when only some pixels that are required in accordance with the data produce luminescence.

Assuming that Lₘₐₓ represents the maximum luminance of individual pixels and Lₖ (k is the number of pixels that are required to produce luminescence in accordance with image data) represents a luminance of individual pixels when only required pixels produce luminescence, the luminance ratio Lᵣ of the data satisfies the formula (2):
Lᵣ=ΣLₖ/ΣLₘₐₓ (2)
and the ratio Lᵣ falls within the range of 0 to 1 inclusive.

When every pixel included in the display panel 11 produces luminescence at a maximum, which means the luminance ratio Lᵣ of image data is 1, the display panel 11 provides the brightest display. As the luminance ratio Lᵣ of image data approaches 1, the number of pixels emitting light increases. A light-emission area is thus enlarged, providing a bright display entirely on the display panel 11. In contrast, as the luminance ratio Lᵣ of image data approaches 0, the number of pixels emitting light decreases. An emission area is thus reduced, providing a dark display almost entirely on the display panel 11.

The luminance data analysis unit 6b generates a control signal to adjust an emission period of the organic EL element, described in greater detail later, during which the pixel emits light based on the calculated luminance ratio of the image data and data stored in the LUT 7. The graphics controller 6 outputs the control signal generated by the luminance data analysis unit 6b as well as the above-mentioned synchronizing signals to the timing controller 8. The LUT 7 stores data defining the emission period of the organic EL element with regard to the luminance ratio of image data. Control of the emission period of the organic EL element based on the data stored in the LUT 7 will be described in greater detail later.

The VRAM 9 outputs the image data from the graphics controller 6 to the data driver 14 included in the display panel unit 3. The timing controller 8 outputs the horizontal synchronizing signal to the data driver 14 included in the display panel unit 3, while outputs the vertical synchronizing signal to the write scan driver 12 also included in the display panel unit 3. The timing controller 8 also outputs an erase scan signal to the erase scan driver 13 included in the display panel unit 3. The erase scan signal makes the organic EL elements in the display panel 11 not emit light. The image data from the VRAM 9 and the signals from the timing controller 8 are synchronized and output to the display panel 11.

Display Panel Unit 3

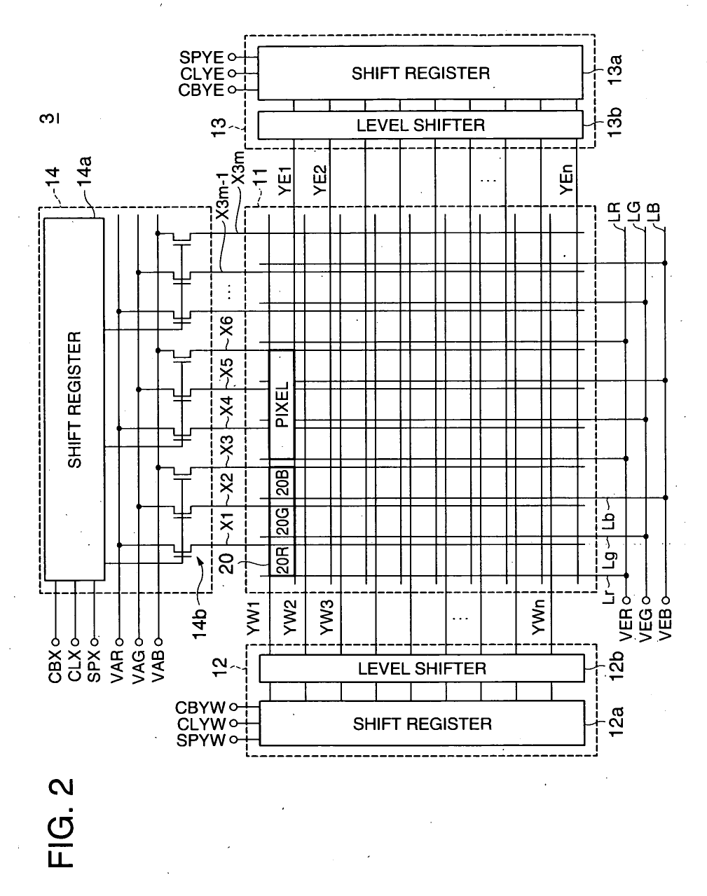

FIG. 2 is a block diagram illustrating the structure of the display panel unit included in the organic EL device according to the first embodiment of the invention. As shown in the diagram, the display panel 11 in the display panel unit 3 includes n-number of write scan lines YW1 to YWn (n is a natural number) extending in the row direction and n-number of erase scan lines YE1 to YEn extending in the row direction. The display panel 11 also includes 3m-number of data lines X1 to X3m (m is a natural number) extending in the column direction perpendicular to the row direction.

The display panel 11 also includes a plurality of pixels 20 disposed at intersections of the write scan lines YW1 to YWn (erase scan lines YE1 to YEn) and the data lines X1 to X3m. In other words, each of the pixels 20 is arranged at an intersection of one of the plurality of write scan lines YW1 to YWn (erase scan lines YE1 to YEn) extending in the row direction and one of the plurality of data lines X1 to X3m extending in the column direction. The pixels 20 are thus electrically coupled with form a matrix.

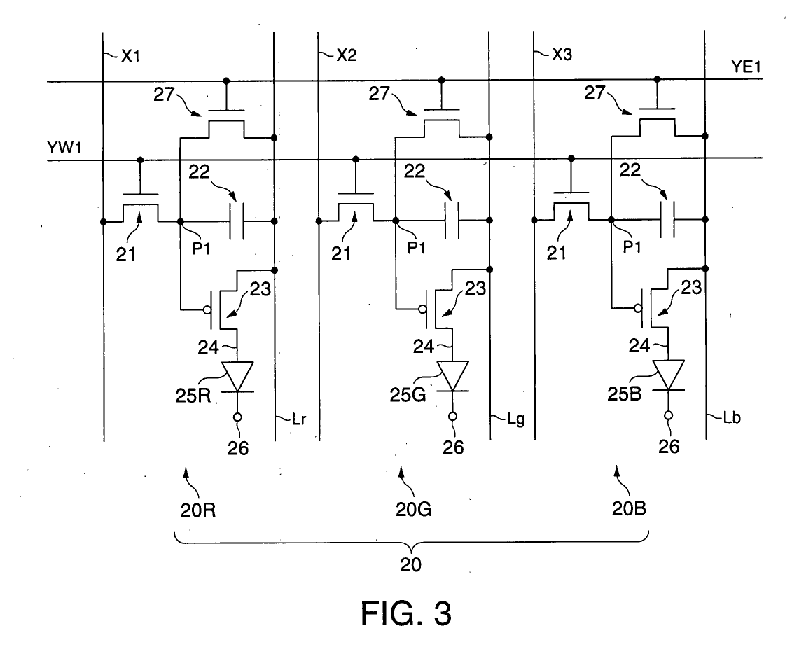

FIG. 3 is a circuit diagram illustrating the structure of one pixel 20 located at the upper left corner of the display panel included in the organic EL device according to the first embodiment of the invention. As shown in the diagram, the pixel 20 on the upper left corner of the display panel 11 includes a subpixel 20R emitting red light, a subpixel 20G emitting green light, and a subpixel 20B emitting blue light.

The other pixels included in the display panel 11 also have the structure made up of the subpixels 20R, 20G, 20B.

The subpixel 20R includes a switching thin-film transistor (TFT) 21 whose gate electrode receives a write scan signal via the write scan line YW1, a storage capacitor 22 retaining a pixel signal supplied from the data line X1 via this switching TFT 21, a driving TFT 23 whose gate electrode receives the pixel signal retained by the storage capacitor 22, a pixel electrode (electrode) 24 receiving a driving current from a power line Lr when electrically coupled with the line Lr via the driving TFT 23, and an organic EL element 25R sandwiched between the pixel electrode 24 and a common electrode 26. In addition, another switching TFT 27 whose gate electrode receives an erase scan signal via the erase scan line YE1 is provided. The source electrode of this' switching TFT is coupled with the power line Lr, while the drain electrode of the TFT is coupled with a point P1 connecting the switching TFT 21, the storage capacitor 22 and the driving TFT 23.

Similarly, the subpixel 20G includes the switching TFT 21 whose gate electrode receives a write scan signal via the write scan line YW1, the storage capacitor 22 retaining a pixel signal supplied from the data line X2 via this switching TFT 21, the driving TFT 23 whose gate electrode receives the pixel signal retained by the storage capacitor 22, the pixel electrode (electrode) 24 receiving a driving current from a power line Lg when electrically coupled with the line Lg via the driving TFT 23, and an organic EL element 25G sandwiched between the pixel electrode 24 and the common electrode 26. In addition, another switching TFT 27 whose gate electrode receives an erase scan signal via the erase scan line YE1 is provided. The source electrode of this switching TFT is coupled with the power line Lg, while the drain electrode of the TFT is coupled with the point P1 connecting the switching TFT 21, the storage capacitor 22 and the driving TFT 23.

Likewise, the subpixel 20B includes the switching TFT 21 whose gate electrode receives a write scan signal via the write scan line YW1, the storage capacitor 22 retaining a pixel signal supplied from the data line X3 via this switching TFT 21, the driving TFT 23 whose gate electrode receives the pixel signal retained by the storage capacitor 22, the pixel electrode (electrode) 24 receiving a driving current from a power line Lb when electrically coupled with the line Lb via the driving TFT 23, and an organic EL element 25B sandwiched between the pixel electrode 24 and the common electrode 26. In addition, another switching TFT 27 whose gate electrode receives an erase scan signal via the erase scan line YE1 is provided. The source electrode of this switching TFT is coupled with the power line Lb, while the drain electrode of the TFT is coupled with the point P1 connecting the switching TFT 21, the storage capacitor 22 and the driving TFT 23.

With this pixel 20, when the write scan line YW1 is driven- to turn on the switching TFT 21, potential of the data lines X1, X2, X3 at this time is stored in the storage capacitors 22 included in the subpixels 20R, 20G, 20B. The on/off state of the driving TFT 23 included in each of the subpixels 20R, 20G, 20B is determined depending on the state of the storage capacitor 22. A current then flows to the pixel electrode 24 included in each of the subpixels 20R, 20G, 20B from the power lines Lr, Lg, Lb, respectively, via a channel in the driving TFT 23. The current therefore flows into the common cathode 26 via each of the organic EL elements 25R, 25G, 25B. As a result, the organic EL elements 25R, 25G, 25B emit light depending on the amount of current flow.

Supposing that the erase scan line YE1 is driven to turn on the switching TFT 27 included in each of the subpixels 20R, 20G, 20B while the write scan line YW1 is not driven, potential of the point P1 included in each of the subpixels 20R, 20G, 20B becomes equal to potential of the power lines Lr, Lg, Lb, respectively. Accordingly, a potential difference in the storage capacitor 22 is zero and the driving TFT 23 that has been on is turned off. Consequently, driving the erase scan line YE1 reduces the potential difference in the storage capacitor 22 to zero, making the organic EL elements 25R, 25G, 25B not emit light (become the off state) even if they have emitted light with the potential of the data lines X1, X2, X3 stored in the storage capacitors 22 included in the each of subpixels 20R, 20G, 20B.

Referring back to FIG. 2, the plurality of power lines Lr, Lg, Lb are arranged in the column direction, so that they are adjacent to the subpixels 20R, 20G, 20B, respectively, in the display panel 11. The power line Lr receives a driving voltage VER via a power supply line LR. Similarly, the power line Lg receives a driving voltage VEG via a power supply line LG, while the power line Lb receives a driving voltage VEB via a power supply line LB. While the present embodiment applies the driving voltages VER, VEG, VEB that differ from each other to the organic EL elements 25R, 25G, 25B, respectively, an identical driving voltage may be applied to the elements 25R, 25G, 25B to drive them by making the power lines Lr, Lg, Lb and the power supply lines LR, LG, LB common to the three.

Peripheral Drive Device 2

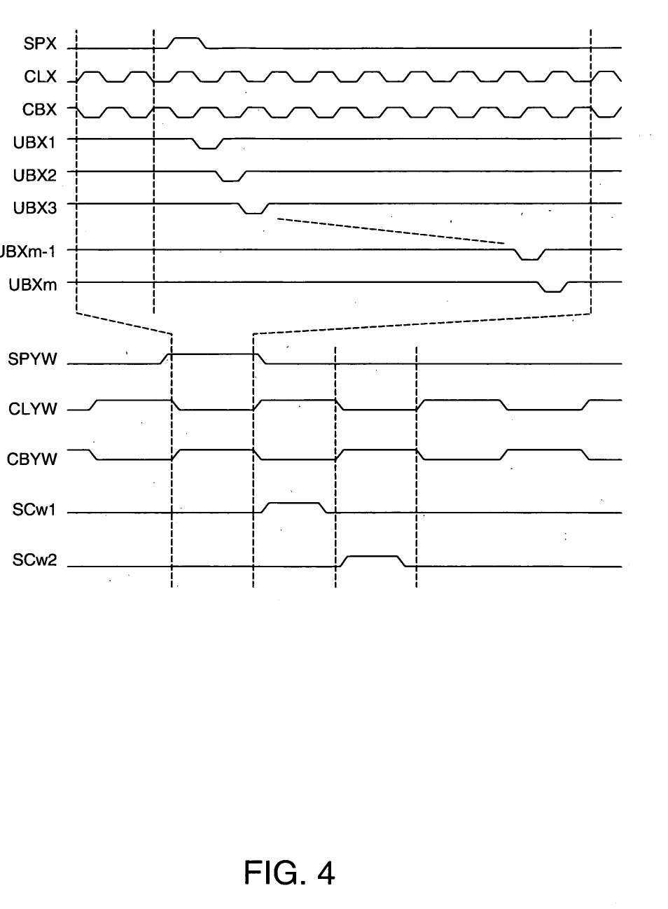

The peripheral drive device 2 will now be described. The peripheral drive device 2 outputs the image data and the synchronizing signals to the display panel unit 3 in sync with a basic clock signal CLK. FIG. 4 is a timing chart illustrating signals output from the peripheral drive device 2 to the display panel unit 3 in the first embodiment of the invention. Referring to this chart, the peripheral drive device 2 generates a data driver start pulse SPX, a data driver clock signal CLX and an inverted data driver clock signal CBX, and outputs them to the data driver 14 included in the display panel unit 3.

The data driver start pulse SPX is output every time one of the write scan lines YW1 to YWn is selected. The pulse is a signal to select one pixel 20 at a time from left to right in FIG. 2 on one selected line out of the lines YW1 to YWn. The data driver clock signal CLX and the inverted data driver clock signal CBX are complementary signals. They are signals to shift the data driver start pulse SPX sequentially. According to the present embodiment, the pixel 20 is made up of a set of the subpixel 20R for red, the subpixel 20G for green and the subpixel 20B for blue. In response to the data driver clock signal CLX and the inverted data driver clock signal CBX, the data driver start pulse SPX is shifted by using the set as a unit, thereby selecting one set of the subpixels 20R, 20G, 20B at a time from left to right in FIG. 2.

The peripheral drive device 2 also produces a write scan driver start pulse SPYW, a write scan driver clock signal CLYW and an inverted write scan driver clock signal CBYW shown in FIG. 4 based on the basic clock signal CLK and outputs the signals to the data driver 14. The write scan driver start pulse SPYW is a signal output when the scan line YW1 on the top is selected out of the write scan lines YW1 to YWn to be selected one by one sequentially from top to bottom. The write scan driver clock signal CLYW and the inverted write scan driver clock signal CBYW are complementary signals. They are signals to shift the write scan driver start pulse SPYW sequentially to select the write scan lines one by one.

The peripheral drive device 2 produces an analog image signal VAR for red, an analog image signal VAG for green and an analog image signal VAB for blue for each pixel 20 (20R, 20G, 20B) based on image data stored in the main memory unit 5. The peripheral drive device 2 outputs the produced signals VAR, VAG, VAB to the data driver 14 in sync with the data driver clock signal CLX and the inverted data driver clock signal CBX.

In other words, the peripheral drive device 2 outputs the analog image data signals VAR, VAG, VAB for one pixel 20 (20R, 20G, 20B) selected at a time from left to right on each selected scan line in sync with the data driver clock signal CLX and the inverted data driver clock signal CBX. The signals VAR, VAG, VAB may fall within a predetermined range and determine the luminance of the organic EL elements 25R, 25G, 25B included in the pixel 20.

As shown in FIG. 2, the peripheral drive device 2 also produces an erase scan driver start pulse SPYE, an erase scan driver clock signal CLYE and an inverted erase scan driver clock signal CBYE based on the basic clock signal CLK and outputs them to the erase scan driver 13. The erase scan driver start pulse SPYE is a signal output when the erase scan line YE1 on the top is selected out of the erase scan lines YE1 to YEn to be selected one by one from top to bottom. The erase scan driver clock signal CLYE and the inverted erase scan driver clock signal CBYE are complementary signals. They are signals to shift the erase scan driver start pulse SPYE sequentially to select the erase scan lines one by one.

The peripheral drive device 2 outputs the write scan driver start pulse SPYW to the write scan driver 12, and then outputs the erase scan driver start pulse SPYE to the erase scan driver 13 at a predetermined timing in each frame. This method makes the organic EL elements 25R, 25G, 25B provided in each pixel 20 not emit light (erased) to adjust the emission period of each element 25R, 25G, 25B.

Write Scan Driver 12 and Erase Scan Driver 13

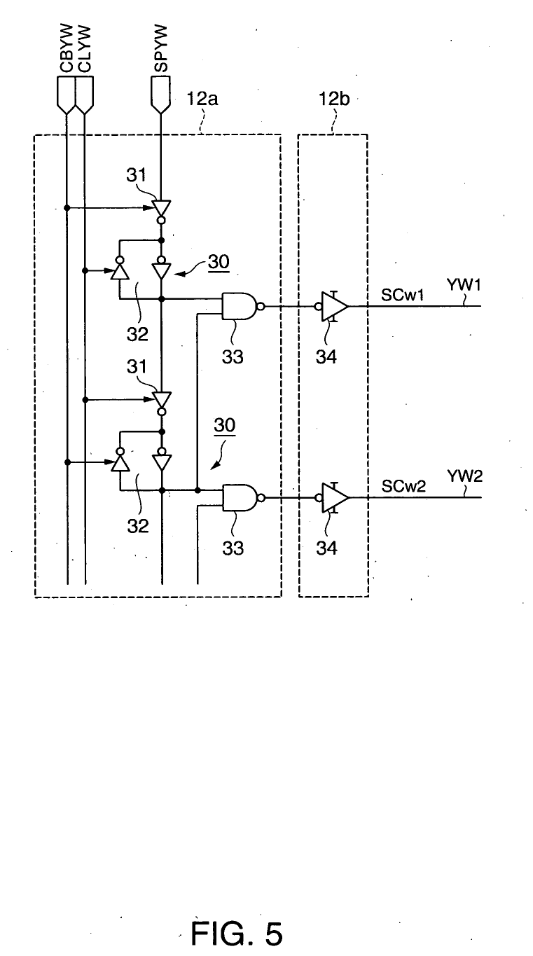

The write scan driver 12 and the erase scan driver 13 will now be described. FIG. 5 is a circuit diagram illustrating the structure of the write scan driver 12 included in the organic EL device according to the first embodiment of the invention. As shown in the diagram, the write scan driver 12 receives the write scan driver start pulse SPYW, the write scan driver clock signal CLYW and the inverted write scan driver clock signal CBYW as inputs from the peripheral drive device 2.

The write scan driver 12 includes a shift register 12a and a level shifter 12b. The shift register 12a includes n-number of storage circuits 30 corresponding to the write scan lines YW1 to YWn as shown in FIG. 5. Here, in the FIG. 5, only two of the storage circuits 30 are illustrated for simplifying the description. Each of the storage circuits 30 includes an inverter circuit 31, a latch part 32 and a NAND circuit 33.

The inverter circuit 31 included in each storage circuit 30 in the odd-numbered stages receives the inverted write scan driver clock signal CBYW as an input, while the inverter circuit 31 included in each storage circuit 30 in the even-numbered stages receives the write scan driver clock signal CLYW as an input as synchronizing signals. The inverter circuit 31 in each storage circuit 30 in the odd-numbered stages receives the write scan driver start pulse SPYW as an input in response to the rising of the inverted write scan driver clock signal CBYW and outputs the pulse to the latch part 32. The inverter circuit 31 in each storage circuit 30 in the even-numbered stages receives the write scan driver start pulse SPYW as an input in response to the rising of the write scan driver clock signal CLYW and outputs the pulse to the latch part 32.

The latch part 32 in each storage circuit 30 is made up of two inverter circuits. The latch part 32 included in each storage circuit 30 in the odd-numbered stages receives the write scan driver clock signal CLYW as an input, while the latch part 32 included in each storage circuit 30 in the even-numbered stages receives the inverted write scan driver clock signal CBYW as an input as synchronizing signals. The latch part 32 in each storage circuit 30 in the odd-numbered stages receives and retains the write scan driver start pulse SPYW as an input from the inverter circuit 31 in response to the rising of the write scan driver clock signal CLYW. The latch part 32 in each storage circuit 30 in the even-numbered stages receives and retains the write scan driver start pulse SPYW as an input from the inverter circuit 31 in response to the rising of the inverted write scan driver clock signal CBYW. Each latch part 32 outputs the write scan driver start pulse SPYW it retains to the inverter circuit 31 in the storage circuit 30 of the next stage. Accordingly, the write scan driver start pulse SPYW at the H level output from the peripheral drive device 2 is sequentially shifted from the storage circuit 30 on the write scan line YW1 to the storage circuit 30 on the write scan line YWn in sync with the write scan driver clock signal CLYW and the inverted write scan driver clock signal CBYW.

The NAND circuit 33 included in one storage circuit 30 has one input terminal coupled with the output terminal of the latch part 32 and another input terminal coupled with the output terminal of the latch par t 32 included in another storage circuit 30 of the next stage. When both the latch parts 32 included in the storage circuit 30 and in the next-stage storage circuit 30 retain the write scan driver start pulse SPYW at the H level, the NAND circuit 33 included in the storage circuit 30 outputs an L-level signal. The NAND circuit 33 outputs an H-level signal when the latch part 32 in the storage circuit 30 shifts the write scan driver start pulse SPYW. The NAND circuit 33 continues to output an H-level signal until each latch part 32 newly retains the write scan driver start pulse SPYW. Here, it takes half a period of the write scan driver clock signal CLYW (inverted write scan driver clock signal CBYW) for the signal output from the storage circuit 30 (NAND circuit 33) to rise to the H level after it falls to the L level.

The signal from the NAND circuit 33 in each storage circuit 30 is output to the level shifter 12b. The level shifter 12b includes n-number of buffer circuits 34 corresponding to the storage circuits 30 as shown in FIG. 5. The buffer circuits 34 are coupled with the write scan lines YW1 to YWn. Accordingly, each of the buffer circuits 34 output signals from the corresponding storage circuit 30 as write scan signals SCw1 to SCwn to the write scan lines YW1 to YWn, respectively. The level shifter 12b selects the write scan lines YW1 to YWn one by one from top to bottom with the write scan signals SCw1 to SCwn, and writes data currents Id1 to Id3m in accordance with the image data in the pixel 20 coupled with the selected write scan line.

As shown in FIG. 2, the erase scan driver 13 receives the erase scan driver start pulse SPYE, the erase scan driver clock signal CLYE and the inverted erase scan driver clock signal CBYE as inputs from the peripheral drive device 2. The erase scan driver 13 includes a shift register 13a and a level shifter 13b. The shift register 13a included in the erase scan driver 13 has a structure similar to the shift register 12a in the write scan driver 12 shown in FIG. 5. The level shifter 13b included in the erase scan driver 13 has a structure similar to the level shifter 13a in the write scan driver 12 shown in FIG. 5. The shift register 13a and the level shifter 13b operate in the same manner as the shift register 12a and level shifter 12b, and therefore the description of their operation is omitted here.

Data Driver 14

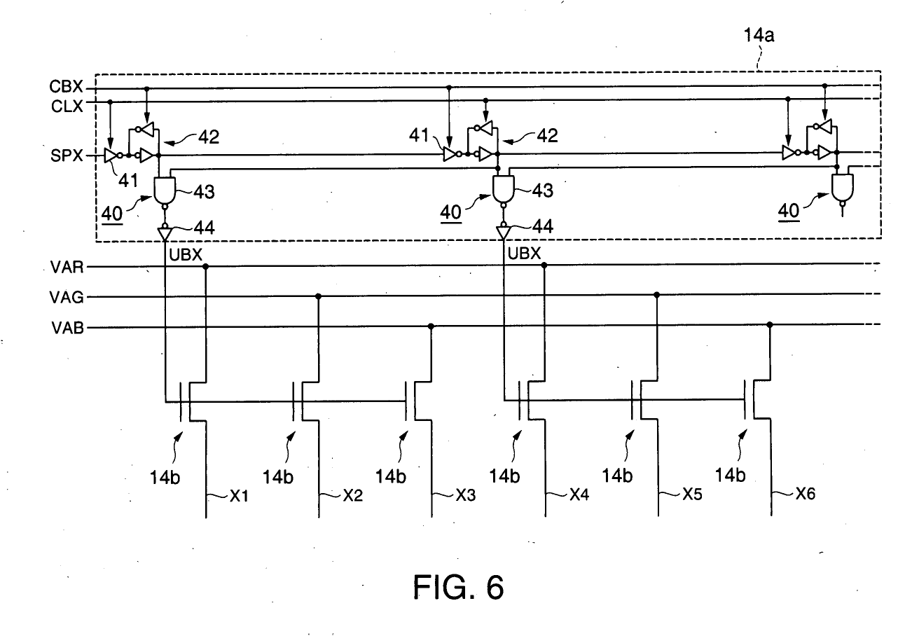

The data driver 14 will now be described. FIG. 6 is a circuit diagram illustrating the structure of the data driver 14 included in the organic EL device according to the first embodiment of the invention. As shown in the diagram, the data driver 14 receives the data driver start pulse SPX, the data driver clock signal CLX and the inverted data driver clock signal CBX as inputs from the peripheral drive device 2. The data driver 14 also receives the analog image signal VAR for red, the analog image signal VAG for green and the analog image signal VAB for blue as inputs from the peripheral drive device 2. The data driver 14 then supplies the data currents Id1 to Id3m to drive the data lines X1 to X3m, respectively, to drive the lines X1 to X3m in sync with the selection of the write scan lines YW1 to YWn based on these signals.

Referring to FIG. 6, the data driver 14 includes a shift register 14a and a plurality (3m-number) of transistors 14b. Here, every three data lines out of the 3m-number of data lines X1 to X3m make up a group. The shift register 14a includes m-number i.e. the number of data line groups) of storage circuits 40. Note that FIG. 6 shows only three of the storage circuits 40 for simplifying the description. Each of the storage circuits 40 includes an inverter circuit 41, a latch part 42, a NAND circuit 43 and another inverter circuit 44.

The inverter circuit 41 included in each storage circuit 40 in odd-numbered stages receives the data driver clock signal CLX as an input, while the inverter circuit 41 included in each storage circuit 40 in even-numbered stages receives the inverted data driver clock signal CBX as an input as synchronizing signals. The inverter circuit 41 of each storage circuit 40 in the odd-numbered stages receives the data driver start pulse SPX as an input in response to the rising of the data driver clock signal CLX and outputs the pulse to the latch part 42. The inverter circuit 41 of each storage circuit 40 in the even-numbered stages receives the data driver start pulse SPX as an input in response to the rising of the inverted data driver clock signal CBX and outputs the pulse to the latch part 42.

The latch part 42 included in each storage circuit 40 is made up of two inverter circuits. The latch part 42 included in each storage circuit 40 in the odd-numbered stages receives the inverted data driver clock signal CBX as an input, while the latch part 42 included in each storage circuit 40 in the even-numbered stages receives the data driver clock signal CLX as an input as synchronizing signals. The latch part 42 included in each storage circuit 40 in the odd-numbered stages receives and retains the data driver start pulse SPX as an input from the inverter circuit 41 in response to the rising of the inverted data driver clock signal CBX. The latch part 42 included in each storage circuit 40 in even-numbered stages receives and retains the data driver start pulse SPX as an input from the inverter circuit 41 in response to the rising of the data driver clock signal CLX. Each latch part 42 outputs the data driver start pulse SPX it retains to the inverter circuit 41 included in the storage circuit 40 of the next stage.

Accordingly, the data driver start pulse SPX at the H level output from the peripheral drive device 2 is sequentially shifted from the storage circuit 40 corresponding to the top three data lines X1 to X3 to the storage circuit 40 corresponding to the bottom three data lines X3m−2 to X3m in sync with the data driver clock signal CLX and inverted data driver clock signal CBX.

The NAND circuit 43 included in one storage circuit 40 has one input terminal coupled with the output terminal of the latch part 42 and another input terminal coupled with the output terminal of the latch part 42 included in another storage circuit 40 of the next stage. When both the latch parts 42 included in the storage circuit 40 and in the next-stage storage circuit 40 retain the data driver start pulse SPX at the H level, the NAND circuit 43 included in the storage circuit 40 outputs an L-level signal. The NAND circuit 43 outputs an H-level signal when the latch part 42 included in the storage circuit 40 shifts the data driver start pulse SPX. The NAND circuit 43 continues to output an H-level signal until each latch part 42 newly retains the data driver start pulse SPX.

It takes half a period of the data driver clock signal CLX (inverted data driver clock signal CBX) for the signal output from the storage circuit 40 (NAND circuit 43) to rise to the H level after it falls to the L level. The output signal from the NAND circuit 43 included in the storage circuit 40 has its level inverted by the inverter circuit 44 and is then output as an inverted output signal UBX. FIG. 4 shows the inverted output signal UBX from UBX1, UBX2, UBX3 to UBXm−1 and UBXm based on the m-number of NAND circuits 43 shown in FIG. 6 from left to right.

Of the plurality of transistors 14b included in the data driver 14, every three transistors make up a group. Each of the three transistors 14b making up a group has a gate electrode coupled with one inverter circuit 44 included in the shift register 14a. Of the three transistors 14b in each group, a first transistor is coupled with a signal line receiving the analog image signal VAR for red, a second transistor is coupled with a signal line receiving the analog image signal VAG for green and a third transistor is coupled with a signal line receiving the analog image signal VAB for blue. The transistors 14b are also coupled with the data lines X1 to X3m correspondingly.

Accordingly, every time the inverted output signal UBX is output from the shift register 14a, a group of the transistors 14b are sequentially turned on, supplying the analog image signals VAR, VAG, VAB to three data lines making up a group. For example, when the inverted output signal UBX is output from the inverter circuit 44 on the left in FIG. 6, the three transistors 14b coupled with this inverter circuit 44 are turned on, supplying the analog image signals VAR, VAG, VAB to the data lines X1, X2, X3, respectively.

The operation of the organic EL device 1 will now be described. The CPU included in the peripheral drive device 2 reads image data stored in the main memory unit 5, carries out various types of processing, such as expansion, with the main memory unit 5, and outputs processed data to the graphics controller 6. When receiving image data of one frame, the graphics controller 6 produces the analog image signals VAR, VAG, VAB for one frame for each pixel 20.

The luminance data analysis unit 6b included in the graphics controller 6 calculates the luminance ratio of the image data output from the CPU 4 based on the data. The luminance data analysis unit 6b determines a period during which the organic EL elements 25R, 25G, 25B are made not emit light (erased) based on the calculated luminance ratio of the image data and data stored in the LUT 7. Upon completion of the above-described process, the graphics controller 6 outputs the analog image signals VAR, VAG, VAB that have been produced to the VRAM 9, and outputs the data including the determined non-emission (erased) period of the organic EL elements 25R, 25G, 25B as well as the synchronizing signals to the timing controller 8.

The analog image signals VAR, VAG, VAB are then output to the data driver 14 together with the data driver start pulse SPX, the data driver clock signal CLX and the inverted data driver clock signal CBX. Meanwhile, the write scan driver start pulse SPYW, the write scan driver clock signal CLYW and the inverted write scan driver clock signal CBYW are output to the write scan driver 12, providing a display on the display panel 11.

Upon the selection of the write scan line YW1 caused by the output of the signals, the organic EL elements 25R, 25G, 25B provided in each pixel 20 on this write scan line YW1 start emitting light with identical emission timing. Subsequently, upon the selection of the write scan line YW2, the organic EL elements 25R, 25G, 25B provided in each pixel 20 on this write scan line YW2 start emitting light with identical emission timing. Likewise, upon the sequential selection of the write scan lines YW3 to YWn, the organic EL elements 25R, 25G, 25B provided in each pixel 20 on these write scan lines YW3 to YWn start emitting light with identical emission timing.

While the scan lines YW1 to YWn are driven, the timing controller 8 in the peripheral drive device 2 outputs the erase scan driver start pulse SPYE together with the erase scan driver clock signal CLYE and the inverted erase scan driver clock signal CBYE to the erase scan driver 13 as a predetermined period of time (emission period of the organic EL elements 25R, 25G, 25B) has elapsed since the write scan line YW1 started to be driven. Upon the output of these signals, the erase scan line YE1 is selected, making the organic EL elements 25R, 25G, 25B provided in the pixel 20 coupled with this erase scan line YE1 not emit light (cleared).

Subsequently, the erase scan line YE2 is selected, making the organic EL elements 25R, 25G, 25B provided in the pixel 20 coupled with this erase scan line YE2 not emit light (cleared). Likewise, the erase scan lines YE3 to YEn are selected sequentially, making the organic EL elements 25R, 25G, 25B provided in each pixel 20 coupled with these erase scan lines YE3 to YEn not emit light (cleared).

Scanning of one frame is completed as the above-described process proceeds to the write scan line YWn, and scanning of the next frame follows. As a predetermined period of time (emission period of the organic EL elements 25R, 25G, 25B) has elapsed since driving of this frame started, the timing controller 8 in the peripheral drive device 2 outputs the erase scan driver start pulse SPYE together with the erase scan driver clock signal CLYE and the inverted erase scan driver clock signal CBYE to the erase scan driver 13 in the same manner as mentioned above. Consequently, the erase scan line YE1 is selected, making the organic EL elements 25R, 25G, 25B provided in the pixel 20 coupled with this erase scan line YE1 not emit light (cleared). Likewise, the erase scan lines YE2 to YEn are selected sequentially, making the organic EL elements 25R, 25G, 25B provided in each pixel 20 coupled with these erase scan lines YE2 to YEn not emit light (cleared).

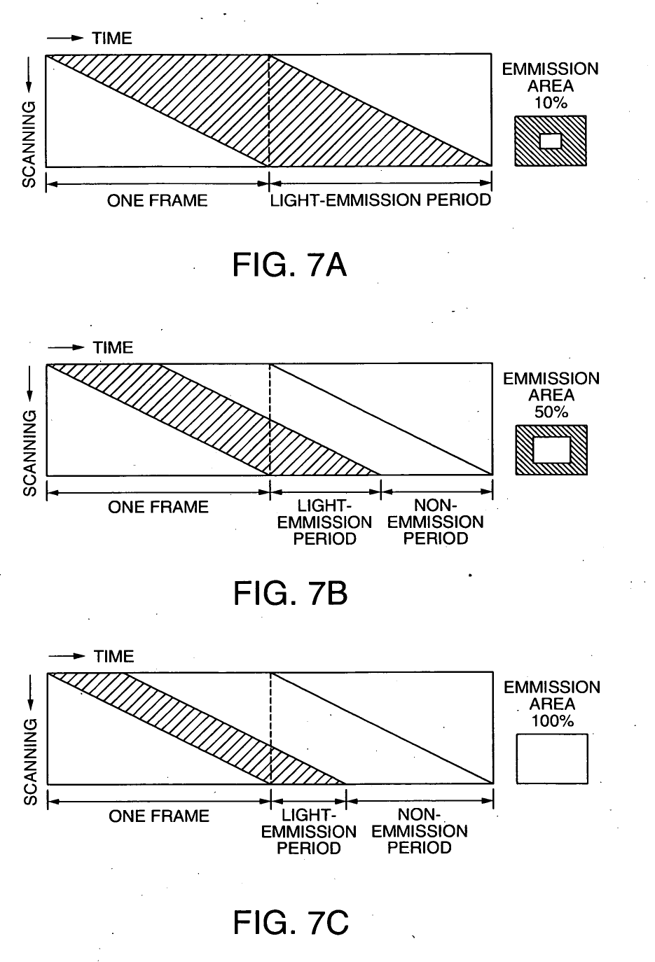

FIG. 7 is a diagram for explaining a method for driving an organic EL device according to one embodiment of the invention. In this diagram, the horizontal direction indicates a lapse of time and the vertical direction indicates the scan direction of the scan lines. FIGS. 7A, 7B and 7C show periods for light-emission and non-emission of the organic EL elements 25R, 25G, 25B when an emission area is 10%, 50% and 100%, respectively. They schematically show the relationship between an entire display and an emission area when the emission area occupies 10%, 50% and 100% of the display.

Referring to FIG. 7A, with a 10% emission area, each of the organic EL elements 25R, 25G, 25B included in pixels on each scan line emits light during one frame. Here, a non-emission period for the elements 25R, 25G, 25B is not set. Referring to FIG. 7B, with a 50% emission area, each of the organic EL elements 25R, 25G, 25B included in pixels on each scan line emits light during the first half of one frame. During the second half, the organic EL elements 25R, 25G, 25B are made not emit light (erased).

Referring to FIG. 7C, with a 100% emission area, each of the organic EL elements 25R, 25G, 25B included in pixels on each scan line emits light only during a predetermined starting period of one frame. During the remaining period, the organic EL elements 25R, 25G, 25B are made not emit light (erased). In this example shown in FIG. 7C, the non-emission period of the organic EL elements 25R, 25G, 25B is set longer than the emission period the elements 25R, 25G, 25B.

The method according to the present embodiment thus adjusts the non-emission timing of the organic EL elements 25R, 25G, 25B depending on emission areas (the luminance ratio of an image to be displayed) to adjust the emission period of the elements 25R, 25G, 25B. Since the voltages (driving voltages VER, VEG, VEB) are fixed irrespective of emission areas the luminance of the organic EL elements 25R, 25G, 25B depends on the emission period. Therefore, luminance can be controlled depending on the luminance ratio of an image to be displayed without changing the voltages (driving voltages VER, VEG, VEB) applied to the organic EL elements 25R, 25G, 25B. Furthermore, since there is no need to change the driving voltages no matter how large the emission area in the present embodiment, high controllability of grayscale is available.

While the examples of FIG. 7 show the 10%, 50% and 100% emission areas, it is also possible to control luminance in continuity depending on emission areas by setting a non-emission period of the organic EL elements 25R, 25G, 25B depending on emission areas. Here, the non-emission timing of the organic EL elements 25R, 25G, 25B is set by the data stored in the LUT 7 shown in FIG. 1. Accordingly, the non-emission timing of the elements 25R, 25G, 25B can be adequately changed simply by changing the LUT data without making a major change in the device structure.

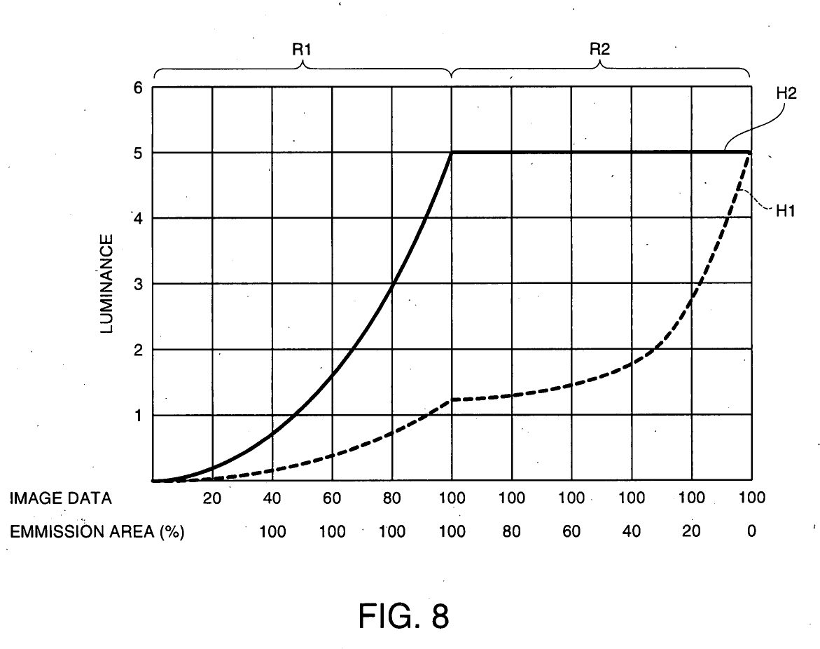

It is desirable that this luminance control depending on emission areas provide as high controllability as cathode ray tube (CRT) displays in related art examples do. FIG. 8 is a diagram showing an example of luminance control of a CRT display and an LCD. In this diagram, the horizontal direction indicates image data and emission area scales and the vertical direction indicates luminance. When the scale of image data shown in the horizontal direction is zero, a dark display is provided. When the scale is 100, a bright display is provided. The diagram can be separated into two graphs. The first graph R1 shows the varying scale of image data from 0 to 100 with a fixed emission area of 100%. The second graph R2 shows varying emission areas from 100% to 0% with a fixed image data scale of 100. Referring to the graphs, the dashed line H1 represents CRT luminance and the solid line H2 represents LCD luminance.

Referring to the first graph R1 in FIG. 8, both the line H1 representing CRT luminance and the line H2 representing LCD luminance show luminance growth as the scale of image data increases. Referring to the first graph R2, while the line H1 representing CRT luminance shows luminance growth nonlinearly in line with decreasing emission areas, the line H2 representing LCD luminance shows a fixed luminance (the luminance when the image data scale is 100). Since organic EL devices in related art examples do not control luminance depending on emission areas, it emits light with a fixed luminance irrespective of changing emission area as shown by the line H2 representing LCD luminance.

In this regard, the above-described method for driving the organic EL device 1 according to the present embodiment controls luminance depending on emission areas and thus can provide highly contrasted images as the CRT does. To provide as high controllability as the CRT does, it is desirable that luminance be controlled in a way it will change nonlinearly depending on emission areas as shown by the line H1 representing CRT luminance.

According to the present embodiment, the storage capacitor 22 included in each of the subpixels 20R, 20G, 20B retains potential for the analog image signals VAR, VAG, VAB, respectively. The driving TFT 23 is controlled with the potential retained in the storage capacitor 22 so as to control a current flowing into the organic EL elements 25R, 25G, 25B. Accordingly, variance in characteristics (threshold voltages) of the organic EL elements 25R, 25G, 25B include in the subpixels 20R, 20G, 20B, respectively, prevents display in accordance with the analog image signals VAR, VAG, VAB.

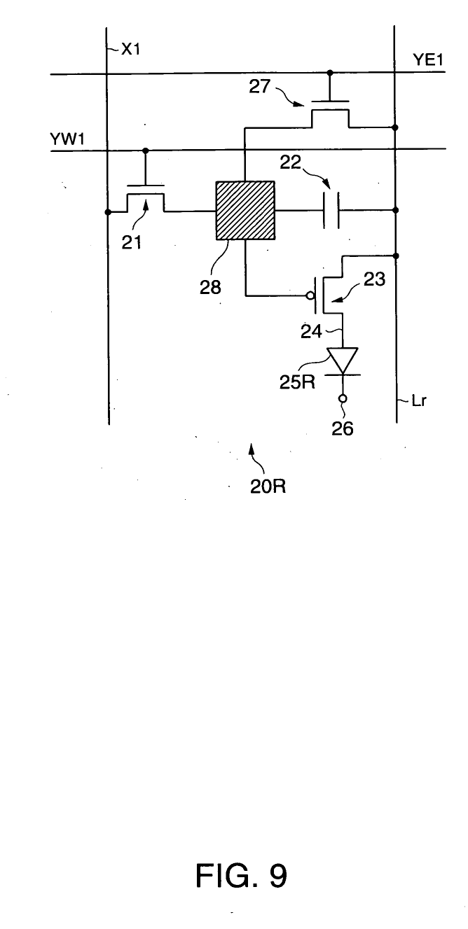

It is therefore desirable that each of the subpixels 20R, 20G, 20B have the structure shown in FIG. 9. FIG. 9 illustrates another structure example showing the subpixel 20R. While only the structure of the subpixel 20R is described here, it is applicable to the subpixels 20G and 20B as well. Referring to the diagram, the subpixel 20R includes a compensation circuit 28 that compensates threshold voltage variance of the driving TFT 23 at the point P1 shown in FIG. 3. The compensation circuit 28 compensates threshold voltage variance of the driving TFT 23 included in each of the subpixels 20R, 20G, 20B. Therefore, it is possible to display quality images.

### Second Embodiment

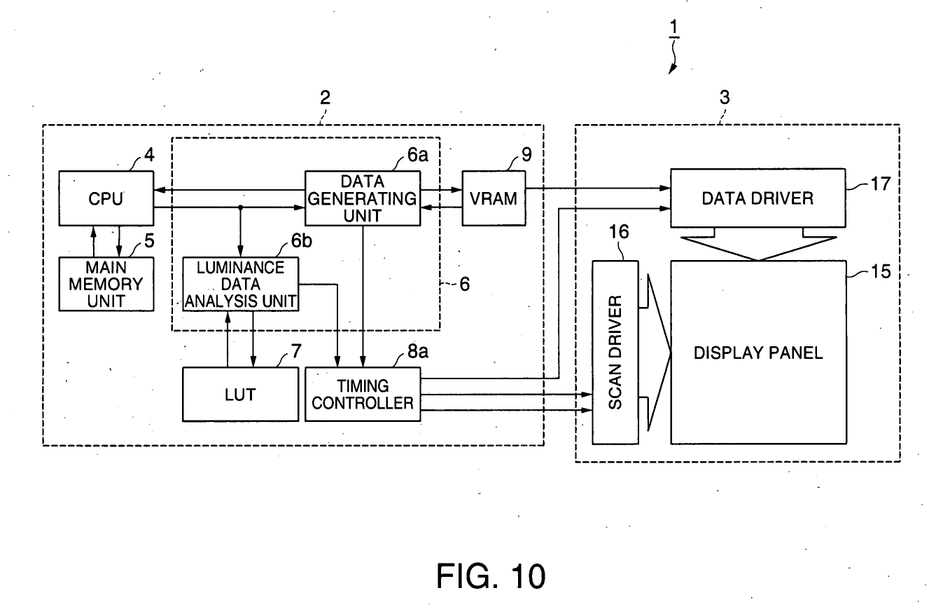

FIG. 10 is a block diagram illustrating the electrical structure of an organic EL device according to a second embodiment of the invention. The same numerals as given in FIG. 1 indicate the same elements here. Referring to FIG. 10, this organic EL device of the second embodiment has the structure of the first embodiment shown in FIG. 1 as a basis in which the erase scan driver 13 is omitted and the display panel 11, the write scan driver 12 and the data driver 14 are replaced with a display panel 15, a scan driver 16 and a data driver 17. Also, the timing controller 8 shown in FIG. 1 is replaced with a timing controller 8a.

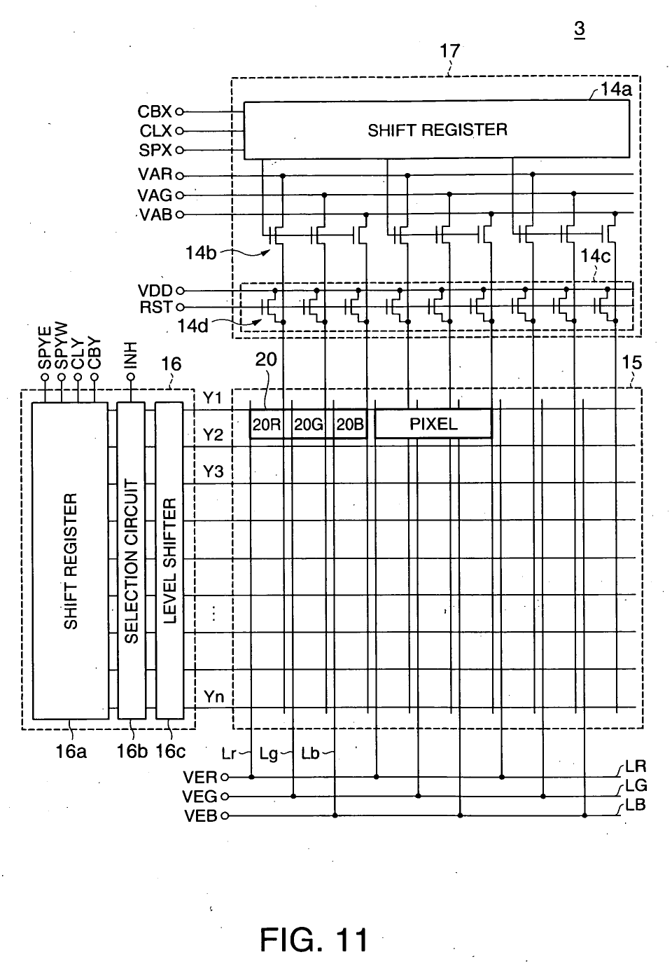

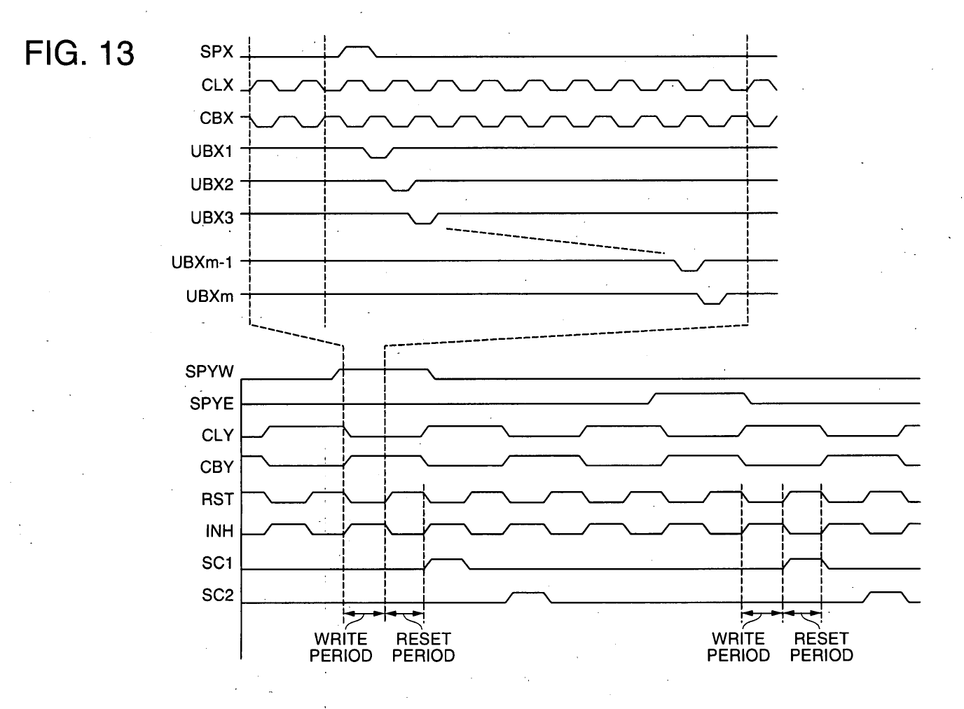

The timing controller 8 shown in FIG. 1 produces the write scan driver clock signal CLYW and the inverted write scan driver clock signal CBYW and outputs them to the write scan driver 12. The timing controller 8a shown in FIG. 10 instead produces a scan driver clock signal CLY and an inverted scan driver clock signal CBY and outputs them to the scan driver 16 (See FIGS. 11 and 13). The scan driver clock signal CLY and the inverted scan driver clock signal CBY are similar to the write scan driver clock signal CLYW and the inverted write scan driver clock signal CBYW, respectively. The timing controller 8a also produces the write scan driver start pulse SPYW and outputs it to the scan driver 16 in the same manner as the timing controller 8. FIG. 13 is a timing chart illustrating signals output from the peripheral drive device 2 to the display panel unit 3 in the second embodiment of the invention.

The timing controller 8 shown in FIG. 1 produces the erase scan driver start pulse SPYE, the erase scan driver clock signal CLYE and the inverted erase scan driver clock signal CBYE and outputs them to the erase scan driver 13. The timing controller 8a shown in FIG. 10 instead produces the erase scan driver start pulse SPYE and a write period selection signal INH and outputs them to the scan driver 16 (See FIG. 11).

Furthermore, the timing controller 8 shown in FIG. 1 produces the data driver start pulse SPX, the data driver clock signal CLX and the inverted data driver clock signal CBX, and outputs them to the data driver 14 included in the display panel unit 3. The timing controller 8a shown in FIG. 10 instead produces a data line reset signal RST as well as the data driver start pulse SPX, the data driver clock signal CLX and the inverted data driver clock signal CBX and outputs them to the data driver 17 (See FIG. 11). The data driver 17 also receives data line reset potential VDD from a power source (not shown).

Display Panel Unit 3

FIG. 11 is a block diagram illustrating the structure of the display panel unit included in the organic EL device according to the second embodiment of the invention. As shown in the diagram, the display panel 15 in the display panel unit 3 has the structure of the display panel 11 shown in FIG. 2 as a basis in which the n-number of write scan lines YW1 to YWn are replaced with n-number of scan lines Y1 to Yn. Also, the erase scan lines YE1 to YEn are omitted as the erase scan driver 13 is omitted.

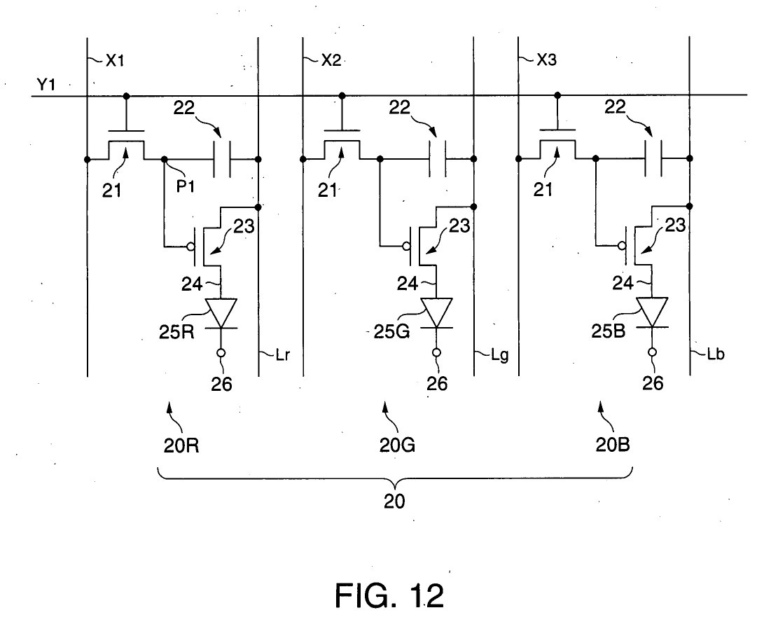

FIG. 12 is a circuit diagram illustrating the structure of one pixel 20 located at the upper left corner of the display panel included in the organic EL device according to the second embodiment of the invention. As shown in the diagram, the pixel 20 on the upper left corner of the display panel 11 includes the subpixel 20R emitting red light, the subpixel 20G emitting green light from its light-emitting layer, and the subpixel 20B emitting blue light from its light-emitting layer. The other pixels included in the display panel 11 also have the structure made up of the subpixels 20R, 20G, 20B.

Each of the subpixels 20R, 20G, 20B includes the switching TFT 21, the storage capacitor 22, the driving TFT 23, the pixel electrode 24 and the common electrode 26 in the same manner as the subpixels 20R, 20G, 20B shown in FIG. 3. The subpixels 20R, 20G, 20B include the organic EL elements 25R, 25G, 25B, respectively. The second embodiment differs from the first embodiment in that the write scan line YE1 is replaced with the scan line Y1, and the erase scan line YE1 and the switching TFT 27 are omitted.

Accordingly, when the scan line Y1 is selected to turn on the switching TFT 21 in each of the subpixels 20R, 20G, 20B, the potential of the data lines X1, X2, X3 at the time is stored in the storage capacitor 22 included in each of the subpixels 20R, 20G, 20B. Then, the on/off state of the driving TFT 23 in each of the subpixels 20R, 20G, 20B is determined depending on the state of the storage capacitor 22. The channel of the driving TFT 23 passes a current from the power lines Lr, Lg, Lb. The current flows into the organic EL elements 25R, 25G, 25B via the pixel electrode 24 in the subpixels 20R, 20G, 20B, respectively. As a result, the organic EL elements 25R, 25G, 25B emit light depending on the amount of current flow.

Scan Driver 16

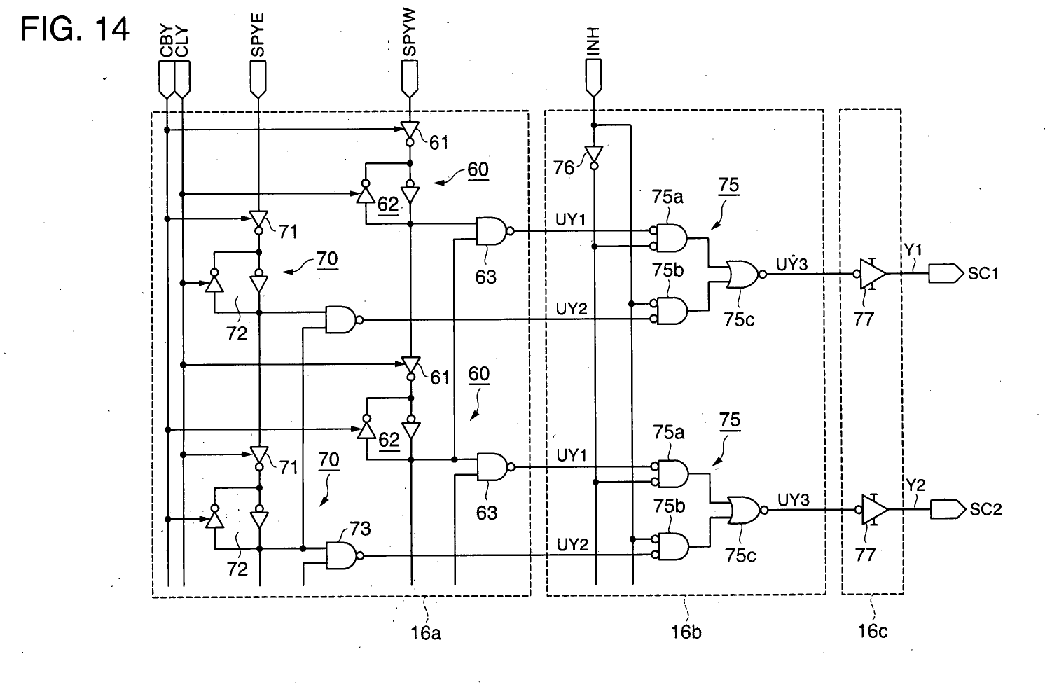

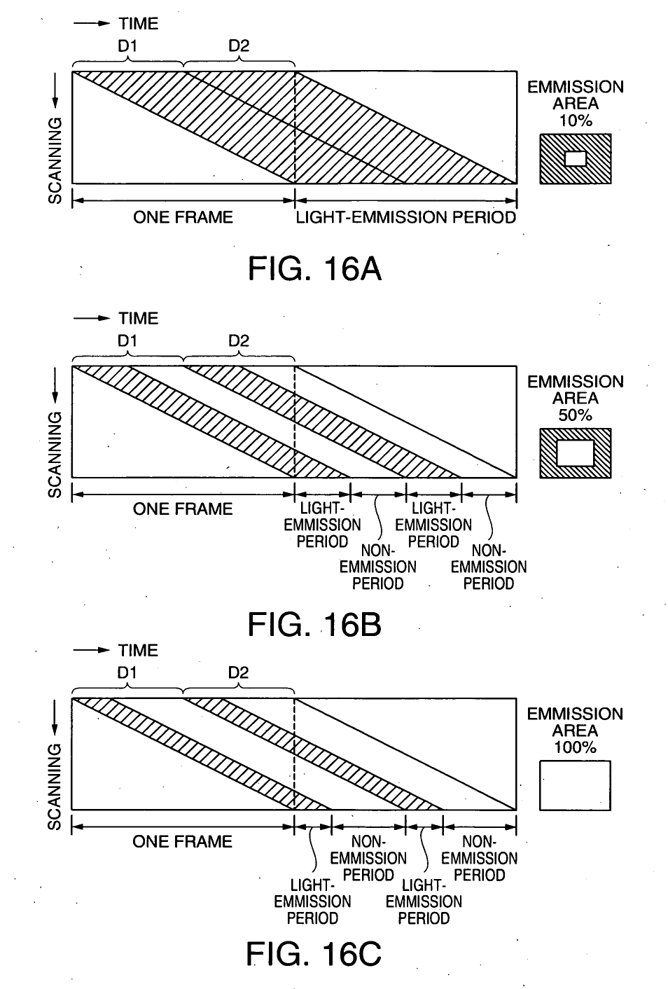

The scan driver 16 will now be described FIG. 14 is a circuit diagram illustrating the structure of the scan driver 16 included in the organic EL device according to the second embodiment of the invention. Referring to the diagram, the scan driver 16 includes a shift register 16a, a selection circuit 16b and a level shifter 16c. The shift register 16a includes n-number of first storage circuits 60 and n-number of second storage circuits 70 both corresponding to the scan lines Y1 to Yn. It is understood that FIG. 16 shows only two of the first storage circuits 60 and two of the second storage circuits 70 for simplifying the description.

Each of the first storage circuits 60 includes an inverter circuit 61, a latch part 62 and a NAND circuit 63. The inverter circuit 61 included in each first storage circuit 60 in odd-numbered stages receives the inverted scan driver clock signal CBY as an input, while the inverter circuit 61 included in each first storage circuit 60 in even-numbered stages receives the scan driver clock signal CLY as an input as synchronizing signals. The inverter circuit 61 in each first storage circuit 60 in the odd-numbered stages receives the write scan driver start pulse SPYW as an input in response to the rising of the inverted scan driver clock signal CBY and outputs the pulse to the latch part 62. The inverter circuit 61 in each first storage circuit 60 in the even-numbered stages receives the write scan driver start pulse SPYW as an input in response to the rising of the scan driver clock signal CLY and outputs the pulse to the latch part 62.

The latch part 62 included in each first storage circuit 60 is made up of two inverter circuits. The latch part 62 included in each first storage circuit 60 in the odd-numbered stages receives the scan driver clock signal CLY as an input, while the latch part 62 included in each first storage circuit 60 in the even-numbered stages receives the inverted scan driver clock signal CBY as an input as synchronizing signals. The latch part 62 in each first storage circuit 60 in the odd-numbered stages receives and retains the write scan driver start pulse SPYW as an input from the inverter circuit 61 in response to the rising of the scan driver clock signal CLY. The latch part 62 in each first storage circuit 60 in the even-numbered stages receives and retains the write scan driver start pulse SPYW as an input from the inverter circuit 61 in response to the rising of the inverted scan driver clock signal CBY. Each latch part 62 outputs the write scan driver start pulse SPYW it retains to the inverter circuit 61 in the first storage circuit 60 of the next stage.

Accordingly, the write scan driver start pulse SPYW at the H level output from the peripheral drive device 2 is sequentially shifted from the first storage circuit 60 on the scan line Y1 to the first storage circuit 60 on the scan line Yn in sync with the scan driver clock signal CLY and the inverted scan driver clock signal CBY.

The NAND circuit 63 included in one first storage circuit 60 has one input terminal coupled with the output terminal of the latch part 62 and another input terminal coupled with the output terminal of the latch part 62 included in another first storage circuit 60 of the next stage. When both the latch parts 62 included in the first storage circuit 60 and in the next-stage first storage circuit 60 retain the write scan driver start pulse SPYW at the H level, the NAND circuit 63 included in the first storage circuit 60 outputs a first output signal UY1 at the L level. The NAND circuit 63 outputs the first output signal UY1 at the H level when the latch part 62 in the first storage circuit 60 shifts and clears the write scan driver start pulse SPYW. The NAND circuit 63 continues to output the first output signal UY1 at the H level until each latch part 62 newly retains the write scan driver start pulse SPYW. Here, it takes half a period of the scan driver clock signal CLY (inverted scan driver clock signal CBY) for the first output signal UY1 from the first storage circuit 60 (NAND circuit 63) to rise to the H level after it falls to the L level.

Each of the second storage circuits 70 includes an inverter circuit 71, a latch part 72 and a NAND circuit 73. The inverter circuit 71 included in each second storage circuit 70 in odd-numbered stages receives the inverted scan driver clock signal CBY as an input, while the inverter circuit 71 included in each second storage circuit 70 in even-numbered stages receives the scan driver clock signal CLY as an input as synchronizing signals. The inverter circuit 71 in the second storage circuit 70 in the odd-numbered stages receives the erase scan driver start pulse SPYE as an input in response to the rising of the scan driver clock signal CLY and outputs the pulse to the latch part 72. The inverter circuit 71 in the second storage circuit 70 in the even-numbered stages receives the erase scan driver start pulse SPYE as an input in response to the rising of the inverted scan driver clock signal CBY and outputs the pulse to the latch part 72.

The latch part 72 included in each second storage circuit 70 is made up of two inverter circuits. The latch part 72 included in each second storage circuit 70 in the odd-numbered stages receives the scan driver clock signal CLY as an input, while the latch part 72 included in each second storage circuit 70 in the even-numbered stages receives the inverted scan driver clock signal CBY as an input as synchronizing signals. The latch part 72 in the second storage circuit 70 in the odd-numbered stages receives and retains the erase scan driver start pulse SPYE as an input in response to the rising of the inverted scan driver clock signal CBY. The latch part 72 in the second storage circuit 70 in the even-numbered stages receives and retains the erase scan driver start pulse SPYE as an input in response to the rising of the scan driver clock signal CLY. Each latch part 72 outputs the erase scan driver start pulse SPYE it retains to the inverter circuit 71 included in the second storage circuit 70 of the next stage.

Accordingly, the erase scan driver start pulse SPYE at the H level output from the peripheral drive device 2 is sequentially shifted from the second storage circuit 70 on the scan line Y1 to the second storage circuit 70 on the scan line Yn in sync with the scan driver clock signal CLY and the inverted scan driver clock signal CBY.

The NAND circuit 73 included in one second storage circuit 70 has one input terminal coupled with the output terminal of the latch part 72 and another input terminal coupled with the output terminal of the latch part 72 included in another second storage circuit 70 of the next stage. When both the latch parts 72 included in the second storage circuit 70 and in the next-stage second storage circuit 70 retain the erase scan driver start pulse SPYE at the H level, the NAND circuit 73 included in the second storage circuit 70 outputs a second output signal UY2 at the L level. The NAND circuit 73 outputs the second output signal UY2 at the H level when the latch part 72 in the second storage circuit 70 shifts and clears the erase scan driver start pulse SPYE. The NAND circuit 73 continues to output the second output signal UY2 at the H level until each latch part 72 newly retains the erase scan driver start pulse SPYE.

It takes half a period of the scan driver clock signal CLY (inverted scan driver clock signal CBY) for the second output signal UY2 from the second storage circuit 70 (NAND circuit 73) to rise to the H level after it falls to the L level.

The first output signal UY1 from each first storage circuit 60 and the second output signal UY2 from each second storage circuit 70 are output to the selection circuit 16b. The selection circuit 16b includes n-number of selection parts 75 corresponding to the scan lines Y1 to Yn. Each of the selection parts 75 includes first, second and third NOR circuits 75a, 75b and 75c. The first NOR circuit 75a has two input terminals one of which receives the first output signal UY1 from the corresponding first storage circuit 60 and the other of which receives the write period selection signal INH via the inverter circuit 76.

The second NOR circuit 75b has two input terminals one of which receives the second output signal UY2 from the corresponding second storage circuit 70 and the other of which receives the write period selection signal INH. The write period selection signal INH inverts in half a period of the inverted scan driver clock signal CBY as shown in FIG. 13 and rises to the H level in response to the rising and falling of the inverted scan driver clock signal CBY. During a period from rising to the H level in response to the inversion of the inverted driver clock signal CBY to the next inversion of the signal CBY, the write period selection signal INH remains at the H level for the first half and at the L level for the second half.

The first NOR circuit 75a outputs an output signal at the H level when the first output signal UY1 is at the L level and the write period selection signal INH is at the H level. In other words, the first NOR circuit 75a outputs an output signal at the H level only for half a period of the inverted scan driver clock signal CBY after the first storage circuit 60 retains the write scan driver start pulse SPYW. Meanwhile, the second NOR circuit 75b outputs an output signal at the H level when both the second output signal UY2 and the write period selection signal INH are at the L level. In other words, the second NOR circuit 75b outputs an output signal at the H level only for half a period of the inverted scan driver clock signal CBY when half a period of the inverted scan driver clock signal CBY has passed since the second storage circuit 70 retained the erase scan start pulse SPYE.

The third NOR circuit 75c has two input terminals one of which receives the output signal from the first NOR circuit 75a and the other of which receives the output signal from the second NOR circuit 75b. When either the first NOR circuit 75a or the second NOR circuit 75b outputs an output signal at the H level, the third NOR circuit 75c outputs a third output signal UY3 at the L level to a buffer circuit 77 included in the next-stage level shifter 16c. When both the first, NOR circuit 75a and the second NOR circuit 75b output an output signal at the L level, the third NOR circuit 75c outputs the third output signal UY3 at the H level to the buffer circuit 77 in the level shifter 16c. The buffer circuit 77 in the level shifter 16c inverts the logic of input signals and outputs them to the scan lines Y1 to Yn as scan signals SC1 to SCn.

The scan driver 16 thus produces the scan signals SC1 to SCn that control the on/off state of the switching TFT 21 included in each pixel 20 on each scan line based on the write scan driver start pulse SPYW and the erase scan driver start pulse SPYE. Specifically, in accordance with the write period selection signal INH, the scan driver 16 inverts the scan signals SC1 to SCn that are based on the write scan driver start pulse SPYW during the first half period (referred to as WRITE PERIOD in FIG. 13) of the inverted scan driver clock signal CBY after each of the first storage circuit 60 retains the write scan driver start pulse SPYW to select the pixel 20. Also in accordance with the write period selection signal INH, the scan driver 16 inverts the scan signals SC1 to SCn that are based on the erase scan driver start pulse SPYE during the second half period (referred to as RESET PERIOD in FIG. 13) of the inverted scan driver clock signal CBY after each of the first storage circuit 60 retains the erase scan driver start pulse SPYE to select the pixel 20.

This means that the scan driver 16 produces the scan signals SC1 to SCn that decide start of the light-emission period of each pixel 20 on each scan line during the write period based on the write scan driver start pulse SPYW. Also, the scan driver 16 produces the scan signals SC1 to SCn that decide start of the non-emission period of each pixel 20 on each scan line during the reset period based on the erase scan driver start pulse SPYE.

Data Driver 17

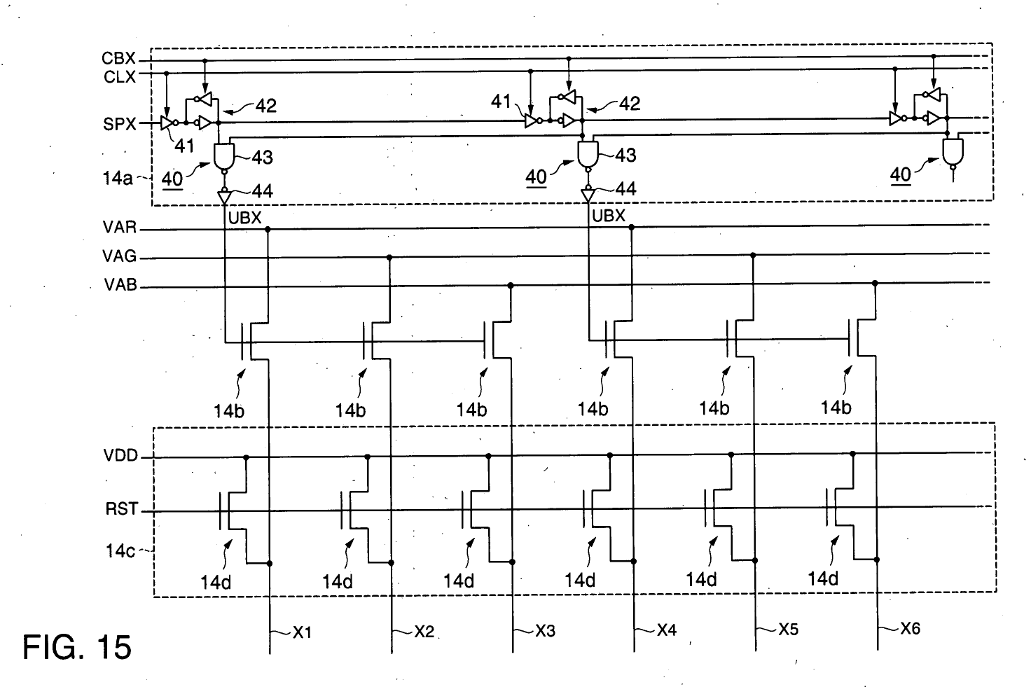

The data driver 17 will now be described. FIG. 15 is a circuit diagram illustrating the structure of the data driver 17 included in the organic EL device according to the second embodiment of the invention. Referring to the diagram, the data driver 17 includes the shift register 14a and the plurality of transistors 14b, which are shown in FIG. 6, and a reset circuit 14c that resets the data lines X1 to X3m.

The reset circuit 14c includes a plurality (3m-number) of transistors 14d corresponding to the transistors 14b. Each of the transistors 14d has a gate electrode coupled with a signal line supplying the data line reset signal RST and a source electrode coupled with a line supplying the data line reset potential VDD. Each of the transistor 14d also has a drain electrode coupled with the data lines X1 to X3m.

If the data line reset signal RST is at the L level with this structure in the same manner as the first embodiment, as the data driver start pulse SPX is input, every time the data driver clock signal CLX and the inverted data driver clock signal CBX are input, the inverter circuit 44 included in the level shifter 14a outputs the inverted output signal UBX sequentially. Based on this inverted output signal UBX, three transistors 14b making up a group are turned on, thereby supplying the analog image signals VAR, VAG, VAB sequentially to the data lines X1 to X3m.

If the data line reset signal RST is at the H level, all the transistors 14d included in the reset circuit 14c are turned on, supplying the data line reset potential VDD to all the data lines X1 to X3m. As the data lines X1 to X3m receive the data line reset potential VDD with the switching TFT 21 being on in each of the subpixels 20R, 20G, 20B shown in FIG. 12, the storage capacitor 22 retains the data line reset potential VDD, thereby turning off the driving TFT 23. This switching makes the organic EL elements 25R, 25G, 25B not emit light.

The operation of the organic EL device 1 with the above-described structure will now be described. In the same manner as the first embodiment, the CPU included in the peripheral drive device 2 reads image data stored in the main memory unit 5, carries out various types of processing, such as expansion, with the main memory unit 5, and outputs processed data to the graphics controller 6. When receiving image data of one frame, the graphics controller 6 produces the analog image signals VAR, VAG, VAB for one frame for each pixel 20.

The luminance data analysis unit 6b included in the graphics controller 6 calculates a luminance ratio of the image data output from the CPU 4 based on the data. The luminance data analysis unit 6b determines a period during which the organic EL elements 25R, 25G, 25B are made not emit light (erased) based on the calculated luminance ratio of the image data and data stored in the LUT 7. Upon completion of the above-described process, the graphics controller 6 outputs the analog image signals VAR, VAG, VAB that have been produced to the VRAM 9, and outputs the data including the determined non-emission (erased) period of the organic EL elements 25R, 25G, 25B as well as the synchronizing signals to the timing controller 8.

The analog image signals VAR, VAG, VAB, together with the data driver start pulse SPX, the data driver clock signal CLX and the inverted data driver clock signal CBX shown in FIG. 13, are then output to the data driver 17. Also, the write scan driver start pulse SPYW, the scan driver clock signal CLY and the inverted scan driver clock signal CBY are output to the scan driver 16. Furthermore, the data line reset signal RST shown in FIG. 13 is output to the data driver 17, while the write period selection signal INH is output to the scan driver 16.

Upon the selection of the scan line Y1 caused by the output of the signals, the organic EL elements 25R, 25G, 25B included in each pixel 20 on this scan line Y1 start emitting light with identical emission timing. Subsequently, upon the selection of the scan line Y2, the organic EL elements 25R, 25G, 25B included in each pixel 20 on this scan line Y2 start emitting light with identical emission timing. Likewise, upon the sequential selection of the scan lines Y3 to Yn, the organic EL elements 25R, 25G, 25B included in each pixel 20 on these scan lines Y3 to Yn start emitting light with identical emission timing.

According to the present embodiment, a period to select one scan line is divided into the first half, i.e. the write period, and the second half, i.e. the reset period, as shown in FIG. 13. The write period selection signal INH is at the H level during the write period referring to FIG. 13. This means that each of the selection parts 75 in the selection circuit 16b shown in FIG. 14 selects the output of the corresponding first storage circuit 60 in the shift register 16a. Accordingly, the write scan driver start pulse SPYW at the H level is sequentially shifted in each first storage circuit 60 in the shift register 16a in sync with the scan driver clock signal CLY and the inverted scan driver clock signal CBY to select the scan lines Y1 to Yn sequentially.

Furthermore, the data reset signal RST is at the L level during the write period referring to FIG. 13. This means that all the transistors 14d in the reset circuit 14c in the data driver 17 shown in FIG. 15 are off. Upon the resultant sequential output of the analog image signals VAR, VAG, VAB from the peripheral drive device 2 to the data lines X1 to X3m, the organic EL elements 25R, 25G, 25B included in each pixel 20 on a selected line out of the scan lines Y1 to Yn start emitting light with identical emission timing.

As a predetermined period of time (emission period of the organic EL elements 25R, 25G, 25B) has elapsed since the write scan driver start pulse SPYW was input, the peripheral drive device 2 outputs the erase scan driver start pulse SPYE to the scan driver 16 (See FIG. 13). Upon the selection of the scan line Y1 by the erase scan driver start pulse SPYE, the organic EL elements 25R, 25G, 25B included in each pixel 20 on this scan line Y1 are made not emit light with identical non-emission timing. Subsequently, upon the selection of the scan line Y2, the organic EL elements 25R, 25G, 25B included in each pixel 20 on this scan line Y2 are made not emit light with identical non-emission timing. Likewise, upon the sequential selection of the scan lines Y3 to Yn, the organic EL elements 25R, 25G, 25B included in each pixel 20 on these scan lines Y3 to Yn are made not emit light with identical non-emission timing.

As mentioned above, the period to select one scan line is divided into two. It is during the reset period that the organic EL elements 25R, 25G, 25B are made not emit light. Since the write period selection signal INH is at the L level during the reset period referring to FIG. 13, each of the selection parts 75 in the selection circuit 16b shown in FIG. 14 selects the output of the corresponding second storage circuit 70 in the shift register 16a. Accordingly, the erase scan driver start pulse SPYE at the H level is sequentially shifted in each second storage circuit 70 in the shift register 16a in sync with the scan driver clock signal CLY and the inverted scan driver clock signal CBY to select the scan lines Y1 to Yn sequentially.

Furthermore, since the data reset signal RST is at the H level during the reset period referring to FIG. 13, all the transistors 14d in the reset circuit 14c in the data driver 17 shown in FIG. 15 are on. Consequently, upon the supply of the data line reset potential VDD to all the scan lines Y1 to Yn, the organic EL elements 25R, 25G, 25B included in each pixel 20 on a selected line out of the scan lines Y1 to Yn are made not emit light with identical non-emission timing.

The input timing of the erase scan driver start pulse SPYE is decided based on the luminance ratio of the image data that is calculated by the luminance data analysis unit 6b and the data-stored in the LUT 7. The peripheral drive device 2 changes the timing to output the erase scan driver start pulse SPYE so as to adjust the non-emission timing of the organic EL elements 25R, 25G, 25B depending on emission areas (the luminance ratio of an image to be displayed). It is thus possible to adjust the emission period of the organic EL elements 25R, 25G, 25B in the same manner as the first embodiment described in FIG. 7.

Since the voltages (driving voltages VER, VEG, VEB) are fixed irrespective of emission areas as in the first embodiment, the luminance of the organic EL elements 25R, 25G, 25B depends on the emission period. Therefore, the luminance can be controlled depending on the luminance ratio of an image to be displayed without changing the voltages (driving voltages VER, VEG, VEB) applied to the organic EL elements 25R, 25G, 25B. Furthermore, since there is no need to change the driving voltages no matter how large the emission area in the present embodiment, high controllability of grayscale is available.

It is desirable that this luminance control depending on emission areas provide as high controllability as cathode ray tube (CRT) displays in related art examples do in the same manner as the first embodiment. Therefore, it is desirable that luminance be controlled nonlinearly depending on emission areas as shown by the line H1 representing CRT luminance in the second graph R2 of FIG. 8. Furthermore, since the present embodiment also uses the analog image signals VAR, VAG, VAB, it is desirable each of that the subpixels 20R, 20G, 20B has the same structure as shown in FIG. 9, in which the compensation circuit 28 compensates threshold voltage variance of the driving TFT 23 included in each of the subpixels 20R, 20G, 20B.

As shown in FIG. 16, one frame is divided into two subframes D1 and D2 in this embodiment. While the time ratio between the two subframes D1 and D2 is desirably 1:1, it can be set adequately. Referring to FIG. 16A, with a 10% emission area, each of the organic EL elements 25R, 25G, 25B included in pixels on each scan line emits light during the subframes D1 and D2. Here, a non-emission period for the elements 25R, 25G, 25B is not set:

Referring to FIG. 16B, with a 50% emission area, each of the organic EL elements 25R, 25G, 25B included in pixels on each scan line emits light during the first half of the subframes D1 and D2. During the second half of the subframes D1 and D2, the organic EL elements 25R, 25G, 25B are made not emit light (erased).

Referring to FIG. 16C, with a 100% emission area, each of the organic EL elements 25R, 25G, 25B included in pixels on each scan line emits light only during a predetermined starting period of the subframes D1 and D2. During the remaining period of the subframes D1 and D2, the organic EL elements 25R, 25G, 25B are made not emit light (erased). In this example shown in FIG. 16C, the non-emission period of the organic EL elements 25R, 25G, 25B is set longer than the emission period thereof.

The method according to the present embodiment divides one frame into the subframes D1 and D2 and adjusts the non-emission timing of the organic EL elements 25R, 25G, 25B depending on emission areas (the luminance ratio of an image to be displayed) to adjust the emission period of the elements 25R, 25G, 25B. This method controls luminance depending on the luminance ratio of an image to be displayed without changing the voltages (driving voltages VER, VEG, VEB) applied to the organic EL elements 25R, 25G, 25B. Furthermore, since there is no need to changing the driving voltages no matter how large the emission area in the present embodiment, high controllability of grayscale is available.

Furthermore, the method according to the present embodiment divides one frame into the subframes D1 and D2 and controls luminance depending on emission areas by using subframes as a unit. This method shortens the period of light-emission and non-emission of the organic EL elements 25R, 25G, 25B. As a result, it is possible to reduce flickering. In addition, since the write scan driver 12, the erase scan driver 13 or the scan driver 16 is provided in a plural number, it is possible to disperse emission areas in a display panel. As a result, it is possible to reduce local power consumption.

While the examples shown in FIG. 16 show the 10%, 50% and 100% emission areas, it is also possible to control luminance in continuity depending on emission areas by setting the non-emission period of the organic EL elements 25R, 25G, 25B for each emission area. The non-emission timing of the organic EL elements 25R, 25G, 25B is set by the data stored in the LUT 7 shown in FIG. 1. Accordingly, the non-emission timing of the elements 25R, 25G, 25B can be adequately changed simply by changing the LUT data without making a major change in the device structure. It is desirable that this luminance control depending on emission areas provide as high controllability as cathode ray tube (CRT) displays in related art examples do in the same manner as the first embodiment. Therefore, it is desirable that luminance be controlled nonlinearly depending on emission areas as shown by the line H1 representing CRT luminance in the second graph R2 of FIG. 8.

Electronic Apparatus

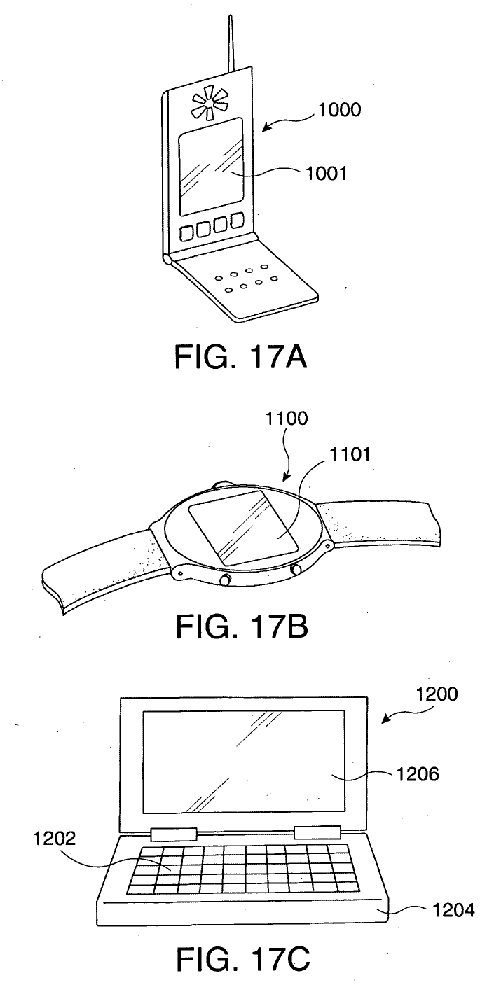

Electronic apparatus examples of the invention will now be described. These apparatus examples three of which are shown in FIG. 17 include the organic EL device 1 as a display. FIGS. 17A through 17C are diagrams illustrating electronic apparatus examples of the invention. FIG. 17A is a perspective view showing an example of cellular phones. Referring to FIG. 17A, a cellular phone 1000 includes a display 1001 using the organic EL device 1. FIG. 17B is a perspective view showing an example of wristwatch type electronic devices. Referring to FIG. 7B, a wristwatch 1100 includes a display 1101 using the organic EL device 1. FIG. 17C is a perspective view showing an example of portable information processors, such as word processors and computers. Referring to FIG. 17C, an information processor 1200 includes an input part 1202 such as a keyboard, a display 1206 using the organic EL device 1, and an information processor body (case) 1204. The examples of FIGS. 17A, 17B and 17C including the displays 1001, 1101, and 1206, respectively, using the organic EL display 1 can provide quality display characteristics.

The organic EL device 1 of the above-described embodiments is also applicable to various electronic apparatuses including viewers, game machines and other portable information terminals, electronic books and electronic paper. In addition, the organic EL display device 1 is also applicable to video cameras, digital cameras, car navigation systems, mobile stereo systems, operation panels, computers, printers, scanners, television sets and video players.

1. An organic electroluminescent device, comprising:
a plurality of pixels, each of the pixels including a light-emitting element; and
a drive device adjusting a light-emission period of the light-emitting element included in each of the pixels in accordance with a luminance ratio of an image to be displayed.

2. The organic electroluminescent device according to claim 1, the drive device adjusting the light-emission period of the light-emitting element by adjusting non-emission timing of the light-emitting element included in each of the pixels.

3. The organic electroluminescent device according to claim 2, further comprising:
a plurality of write scan lines each provided for a unit composed of a predetermined number of the pixels;
a plurality of erase scan lines provided corresponding to the write scan lines; and
a plurality of data lines each provided for a unit composed of the predetermined number of the pixels, the data lines extending in a direction orthogonal to the write scan lines and the erase scan lines;
the drive device making the light-emitting element included in each of the pixels emit light via the write scan lines and making the light-emitting element included in each pixel not emit light via the erase scan lines.

4. The organic electroluminescent device according to claim 3, the drive device including a plurality of write scan drivers, each of the write scan drivers driving a unit composed of a predetermined number of the write scan lines.

5. The organic electroluminescent device according to claim 3, the drive device including a plurality of erase scan drivers, each of the erase scan drivers driving a unit composed of a predetermined number of the erase scan lines.

6. The organic electroluminescent device according to claim 5, the drive device dividing a predetermined unit period into a number of one of the write scan drivers and the erase scan drivers and controlling light-emission and non-emission of the light-emitting element in each divided period.

7. The organic electroluminescent device according to claim 3, each of the pixels including a driving element driving the light-emitting element based on a signal from the write scan lines and the data lines, and
a compensation circuit compensating characteristic variance of the driving element.

8. The organic electroluminescent device according to claim 2, further comprising:
a plurality of scan lines each provided for a unit composed of a predetermined number of the pixels; and
a plurality of data lines each provided for a unit composed of the predetermined number of the pixels, the data lines extending in a direction orthogonal to the scan lines;
the drive device dividing a period to select one of the plurality of scan lines into a first period and a second period and adjusting the light-emission period of the light-emitting element.

9. The organic electroluminescent device according to claim 8, the drive device including a plurality of scan drivers, each of the scan drivers driving a unit composed of a predetermined number of the scan lines.

10. The organic electroluminescent device according to claim 9, the drive device dividing each of the first period and the second period into a number of the scan drivers and controlling light-emission and non-emission of the light-emitting element in each divided period.

11. The organic electroluminescent device according to claim 8, each of the pixels including a driving element driving the light-emitting element based on a signal from the scan lines and the data lines, and
a compensation circuit compensating characteristic variance of the driving element.

12. The organic electroluminescent device according to claim 2, each of the pixels including a red-light-emitting element, a green-light-emitting element, and a blue-light-emitting element, and
the drive device making the red-light-emitting element, the green-light-emitting element, and the blue-light-emitting element included in each of the pixels emit light with identical light-emission timing, and making the red-light-emitting element, the green-light-emitting element, and the blue-light-emitting element included in each of the pixels not emit light with identical non-emission timing.

13. The organic electroluminescent device according to claim 1, the drive device adjusting the light-emission period of the light-emitting element in a way that luminance of the light-emitting element is nonlinear with respect to a luminance ratio of an image to be displayed.

14. A method for driving an organic electroluminescent device including a plurality of pixels, each of the pixels having a light-emitting element, comprising:
adjusting a light-emission period of the light-emitting element included in each of the pixels in accordance with a luminance ratio of an image to be displayed.

15. The method for driving an organic electroluminescent device according to claim 14, wherein the light-emission period of the light-emitting element is adjusted by adjusting non-emission timing of the light-emitting element included in each of the pixels.

16. The method for driving an organic electroluminescent device according to claim 15, wherein each of the pixels includes a red-light-emitting element, a green-light-emitting element, and a blue-light-emitting element, and
the red-light-emitting element, the green-light-emitting element, and the blue-light-emitting element included in each of the pixels are made emit light with identical light-emission timing, and the red-light-emitting element, the green-light-emitting element, and the blue-light-emitting element included in each of the pixels are made not emit light with identical non-emission timing.

17. The method for driving an organic electroluminescent device according to claim 14, wherein the light-emission period of the light-emitting element is adjusted in a way that luminance of the light-emitting element is nonlinear with respect to a luminance ratio of an image to be displayed.

18. An electronic apparatus, comprising:
the organic electroluminescent device according to claim 1.
